(19) United States
(12) Patent Application Publication
(10) Pub. No.: US 2025/0282501 A1
(43) Pub. Date: Sep. 11, 2025

(54) AERIAL VEHICLE, AERIAL VEHICLE SYSTEM AND METHOD OF AERIAL LIFTING

(71) Applicant: Nanyang Technological University, Singapore (SG)

(72) Inventors: Mir Alikhan Bin Mohammad Feroskhan, Singapore (SG); Liangming Chen, Singapore (SG); Jiaping Xiao, Singapore (SG); Yumin Zheng, Singapore (SG); N Arun Alagappan, Singapore (SG)

(21) Appl. No.: 19/048,519

(22) Filed: Feb. 7, 2025

(30) Foreign Application Priority Data
Mar. 8, 2024 (SG) 10202400651Q

(51) Int. Cl. B64U 50/19; B64C 11/48; B64D 27/34; B64D 27/40; B64U 10/13; B64U 101/60

(52) U.S. Cl. CPC B64U 50/19; B64C 11/48; B64D 27/34; B64D 27/402; B64U 10/13; B64U 2101/60

(57) ABSTRACT

An aerial vehicle with a first motor that includes a first output shaft defining a first output axis. Additionally, the aerial vehicle includes a first mount coupled to the first output shaft, where the first mount is angularly displaceable about the first output axis by the first output shaft. Furthermore, the aerial vehicle includes a second motor coupled to the first mount, where the second motor includes a second output shaft defining a second output axis. Additionally, the aerial vehicle includes a second mount coupled to the second output shaft, where the second mount is angularly displaceable about the second output axis by the second output shaft. Furthermore, the aerial vehicle includes a pair of propellers coupled to the second mount, where the pair of propellers defines a volumetric thrust stream along the common propeller axis, and where the centre of mass is disposed interior of the volumetric thrust stream.

### CROSS-REFERENCE TO RELATED APPLICATION

This application claims the benefit of priority to the Singapore application no. 10202400651Q filed Mar. 8, 2024, the contents of which are hereby incorporated by reference in their entirety for all purposes.

### TECHNICAL FIELD

This application relates to an aerial moving, and more particularly to an aerial vehicle, an aerial vehicle system, and a method of aerial lifting.

### BACKGROUND

With the recent technological advancements in aerial vehicles' power supply, communication, and onboard computation, the use of quadrotors in various engineering applications has become increasingly popular. In particular, quadrotors can provide increased safety and reduce the cost of operations in high-risk tasks or environments, such as disaster management, search and rescue, bridge and building inspection. However, the maximum thrust per platform area, i.e., thrust efficiency, for quadrotors is generally limited.

### SUMMARY

According to an aspect, disclosed herein is an aerial vehicle. The aerial vehicle comprises: a housing (or fuselage) defining a housing axis, the housing axis passing through a centre of mass of the housing; a first motor coupled to the housing, the first motor including a first output shaft defining a first output axis; a first mount coupled the first output shaft, the first mount angularly displaceable about the first output axis by the first output shaft; a second motor coupled to the first mount, the second motor including a second output shaft defining a second output axis; a second mount coupled to the second output shaft, the second mount angularly displaceable about the second output axis by the second output shaft; a pair of propellers coupled to the second mount, the pair of propellers rotatable about a common propeller axis, wherein the pair of propellers define a volumetric thrust stream along the common propeller axis, wherein the centre of mass of the housing is disposed interior of the volumetric thrust stream.

According to another aspect, disclosed herein an aerial vehicle system for moving a load. The aerial vehicle system comprises: multiple ones of the aerial vehicle as described above; and a control station, the control station being configured to independently wirelessly control each of the multiple ones of the aerial vehicle

According to yet another aspect, disclosed herein method of aerial lifting. The method comprises: detachably coupling a plurality of the aerial vehicles as described above to a plurality of coupling points of a load; and independently controlling each of the aerial vehicle to a respective target position to vary a position of the load, wherein each of the respective target position is distinct from one another.

### BRIEF DESCRIPTION OF THE DRAWINGS

Various embodiments of the present disclosure are described below with reference to the following drawings:

FIG. 1 is a schematic diagram of an aerial vehicle system according to embodiments of the present disclosure;

FIG. 2 is a schematic illustration of an aerial vehicle according to various embodiments;

FIG. 3 is a perspective view of an aerial vehicle according to various embodiments;

FIG. 4 is an exploded view of the aerial vehicle of FIG. 3;

FIG. 5 is a side view of an aerial vehicle in a neutral state according to various embodiments;

FIG. 6 is a side view of an aerial vehicle in flight performing a single angular rotation thrust vectoring according to various embodiments;

FIG. 7 is a side view of an aerial vehicle in flight performing another single angular rotation thrust vectoring according to various embodiments;

FIG. 8 is a perspective view of an aerial vehicle in flight performing a double angular rotation thrust vectoring according to various embodiments;

FIG. 9 is a side view of an aerial vehicle in flight under disturbance according to various embodiments;

FIGS. 10A and 10B are top views of an aerial vehicle system lifting a load according to various embodiments;

FIGS. 11A and 11B are another top views of another aerial vehicle system lifting a load according to various embodiments;

FIG. 12 is a schematic diagram showing a respective flight path and respective target position of multiple aerial vehicles lifting a load according to various embodiments;

FIG. 13 is a flowchart showing a method of aerial lifting according to various embodiments;

FIG. 14 shows an isometric view of a coaxial drone;

FIG. 15A shows a front view of the coaxial drone in a positive roll state in which a first servomotor is engaged in rotation;

FIG. 15B shows a perspective view of the coaxial drone in a positive roll and positive pitch state, in which a first servo motor and a second servomotor is engaged in rotation;

FIG. 15C shows a front view of the coaxial drone in a positive pitch state, in which a second servomotor is engaged in rotation;

FIG. 16 shows top views of a rotor disc area, a drone footprint area, and a constant payload size of (left) a quadrotor and (right) a coaxial drone;

FIG. 17A shows a plot of position tracking error in the x, y and z directions (per meter or m) as a function of time (in second or s), illustrating the simulation results of the mathematical model for the hovering case of a coaxial drone with damping;

FIG. 17B shows a plot of attitude of the pitch, roll and yaw (in radian or rad) as a function of time (in second or s), illustrating the simulation results of the mathematical model for the hovering case of a coaxial drone with damping;

FIG. 17C shows a plot of motor output parameters, including the squared rotational speeds of two motors, Ω₁² and Ω₂² (in revolution per minute or RPM), the roll angle, δᵣ_{_{ϕ}} and the pitch angle, δᵣ_{_{θ}} (in radian or rad) as functions of time (in seconds or s), illustrating the simulation results of the mathematical model for the hovering case of a coaxial drone with damping;

FIG. 17D shows a 3-Dimensional (3D) plot of the trajectory of the system in space, with positions along the x, y, and z axes (per meter or m), illustrating the simulation results of the mathematical model for the hovering case of a coaxial drone with damping;

FIG. 18A shows a plot of position tracking error in the x, y and z directions (per meter or m) as a function of time (in second or s), illustrating the simulation results of the mathematical model for the hovering case of a coaxial drone without damping;

FIG. 18B shows a plot of attitude of the pitch, roll and yaw (in radian or rad) as a function of time (in second or s), illustrating the simulation results of the mathematical model for the hovering case of a coaxial drone without damping;

FIG. 18C shows a plot of motor output parameters, including the squared rotational speeds of two motor, Ω₁² and Ω₂² (in revolution per minute or RPM), the roll angle, δᵣ_{_{ϕ}} and the pitch angle, δᵣ_{_{θ}} (in radian or rad) as functions of time (in second or s), illustrating the simulation results of the mathematical model for the hovering case of a coaxial drone without damping;

FIG. 18D shows a 3-Dimensional (3D) plot of the trajectory of the system in space, with positions along the x, y, and z axes (per meter or m), illustrating the simulation results of the mathematical model for the hovering case of a coaxial drone without damping;

FIG. 19A shows a plot of position tracking error in the x, y and z directions (per meter or m) as a function of time (in second or s), illustrating the simulation results of the mathematical model for the maneuvering case of a coaxial drone;

FIG. 19B shows a plot of attitude of the pitch, roll and yaw (in radian or rad) as a function of time (in second or s), illustrating the simulation results of the mathematical model for the maneuvering case of a coaxial drone;

FIG. 19C shows a plot of motor output parameters, including the squared rotational speeds of two motors, Ω₁²/10³ and Ω₂²/10³ (in revolution per minute or RPM), the roll angle, δᵣ_{_{ϕ}} and the pitch angle, δᵣ_{_{θ}} (in radian or rad) as functions of time (in second or s), illustrating the simulation results of the mathematical model for the maneuvering case of a coaxial drone;

FIG. 19D shows a 3-Dimensional (3D) plot of the trajectory of the system in space, with positions along the x, y, and z axes (per meter or m), illustrating the simulation results of the mathematical model for the hovering case of a coaxial drone with damping;

FIG. 20A shows a plot of position tracking error in the x, y and z directions (per meter or m) as a function of time (in second or s), illustrating the simulation results of the physical model for the hovering case of a coaxial drone;

FIG. 20B shows a plot of the roll angle, δᵣ_{_{ϕ}} and the pitch angle, δᵣ_{_{θ}} (in radian or rad) as a function of time (in second or s), illustrating the simulation results of the physical model for the hovering case of a coaxial drone;

FIG. 20C shows a 3-Dimensional (3D) plot of the trajectory of the system in space, with positions along the x, y, and z axes (per meter or m), illustrating the simulation results of the mathematical model for the physical model for the hovering case of a coaxial drone;

FIG. 21A shows a plot of position tracking error in the x, y and z directions (per meter or m) as a function of time (in second or s), illustrating the simulation results of the physical model for the maneuvering case of a coaxial drone;

FIG. 21B shows a plot of the roll angle, δᵣ_{_{ϕ}} and the pitch angle, δᵣ_{_{θ}} (in radian or rad) as a function of time (in second or s), illustrating the simulation results of the physical model for the maneuvering case of a coaxial drone;

FIG. 21C shows a 3-Dimensional (3D) plot of the trajectory of the system in space, with positions along the x, y, and z axes (per meter or m), illustrating the simulation results of the mathematical model for the physical model for the maneuvering case of a coaxial drone;

FIG. 22 shows an image illustrating a designed coaxial drone and its main components including a Time-Of-Flight (TOF) sensor, an Inertia Measurement Unit (IMU) and a Printed Circuit Board (PCB) having a Microcontroller Integrated Circuit (MCU);

FIG. 23 shows schematics illustrating the various connections between electrical components of the drone;

FIG. 24A shows an image illustrating a coaxial drone mounted to a testing platform that measures the coaxial drone's thrust efficiency;

FIG. 24B shows an image illustrating an enlarged view of FIG. 24A, focusing on the location where a high-precision sensor is mounted;

FIG. 25 shows a plot of thrust (in Newton or N) as a function of the Pulse Width Modulation (PWM) signal (in microsecond or s), illustrating the testing results produced by the coaxial drone and the quadrotor;

FIG. 26 shows a plot of thrust (in Newton or N) as a function of the produced current (in Ampere or A), illustrating the testing results produced by the coaxial drone and the quadrotor;

FIG. 27 shows a plot of power (in Watt or W) as a function of thrust (in Newton or N), illustrating the testing results produced by the coaxial drone and the quadrotor;

FIG. 28A shows an image illustrating a coaxial drone with a propeller span of 10 inches;

FIG. 28B shows an image illustrating a quadrotor with a propeller span of 5 inches;

FIG. 29 shows an image illustrating a laboratory set up for the approximate characterization of the system performance of the drone's roll dynamics;

FIG. 30 shows an image illustrating the motion sequence of the coaxial drone during a vertical ascending flight;

FIG. 31A shows a plot of position tracking error in the x, y and z directions (per meter or m) as a function of time (in second or s), illustrating the experimental data of the coaxial drone during a vertical ascending flight;

FIG. 31B shows a plot of attitude of the pitch, roll and yaw (in radian or rad) as a function of time (in second or s), illustrating the experimental data of the coaxial drone during a vertical ascending flight;

FIG. 31C shows a plot of motor output parameters, including the Power Width Modulation (PWM) signal (in microsecond or s), the roll angle, δᵣ_{_{ϕ}} and the pitch angle, δᵣ_{_{θ}} (in radian or rad) as functions of time (in second or s), illustrating the experimental data of the coaxial drone during a vertical ascending flight;

FIG. 31D shows a 3-Dimensional (3D) plot of the trajectory of the system in space, with positions along the x, y, and z axes (per meter or m), illustrating the experimental data of the coaxial drone during a vertical ascending flight;

FIG. 32A shows a plot of position measurement in the x, y and z direction (in meter or m) as a function of time (in second or s), illustrating the experimental data of the coaxial drone during a hover flight;

FIG. 32B shows a plot of attitude of the pitch, roll and yaw (in radian or rad) as a function of time (in second or s), illustrating the experimental data of the coaxial drone during a hover flight;

FIG. 32C shows a plot of motor output parameters, including the Power Width Modulation (PWM) signal (in microsecond or s), the roll angle, δᵣ_{_{ϕ}} and the pitch angle, δᵣ_{_{θ}} (in radian or rad) as functions of time (in second or s), illustrating the experimental data of the coaxial drone during a hover flight;

FIG. 32D shows a plot of voltage (in Voltage or V) as a function of time (in second or s), illustrating the experimental data of the coaxial drone during a hover flight.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

The term “pose” may include a position and an orientation of an object or part of an object. The term “position” may refer to a location or coordinate (for example, X-coordinate, Y coordinate, Z coordinate) of an object or part of an object in a space or a frame. The term “orientation” may refer to a facing or angle (for example, an X-direction vector, a Y-direction vector, a Z-direction vector) of an object or part of an object in a space or a frame.

The term “housing”, “fuselage”, “body”, “casing”, “frame”, “platform” may be used interchangeably, and may generally refer to a main body of the aerial drone. For examples, the main body may hold or be coupled to components of the aerial vehicle, such as controllers, printed circuit boards, power sources, communication devices, sensors, cablings, wires, etc. In addition, the main body may act as a main loading structure providing one or more coupling points for detachable peripheral devices, such as a holder or a grasper.

As used herein, the term “motor” may generally refer to an actuator providing a rotational motion. The actuator may include one or more of a linear driver, a rotary driver, a servomotor, a DC motor, an AC motor, an actuating mechanism, a cam, a set of gears, etc.

As used herein, the term “volumetric thrust stream” generally refers to a volumetric airflow generated by rotations of the propeller(s). As an example, the volumetric thrust stream may generally be defined by the diameter of the propeller and a length of the aerial vehicle orthogonal to the rotation of the propeller.

Quadrotors enjoy a high stability in hover and a high maneuverability in controlled movements involving roll and pitch motions. However, the maximum thrust per platform area, i.e., thrust efficiency, for quadrotors is generally limited due to the presence of four propellers, whose rotor size is proportional to the central body. Note that the maximum thrust per platform area is an important index for a drone's flight duration and power consumption. As output power needed to hover is proportional to the inverse of the rotor's radius, thrust efficiency is limited by the number and size of rotors.

The present disclosure proposes an aerial vehicle with a pair of coaxial contra-rotating rotors or propellers to provide a compact and high thrust efficiency solution. The pair of propellers may achieve independent bi-axial rotation about two orthogonal axes. In various embodiments, the proposed aerial vehicle is able to vary or control the thrust vectoring of the aerial vehicle via a simple mechanism.

The proposed coaxial aerial vehicle may comprise two motors (such as servomotors) connected directly to the pair of propellers or propeller system. This may be achieved using individual rotation mounts, under which the parallel coaxial propellers do not need to tilt with respect to the rotors' brushless motor to achieve thrust vectoring. This preserves the four maneuvering degrees of freedom with a higher thrust per platform area in comparison to a conventional quadrotor. A platform or mount may be used to control the direction of flight, in which servomotors which are attached to the platform may change the pitch of the propeller blades at each rotation cycle and then generate thrust components parallel to the desired direction.

The proposed coaxial drone simultaneously satisfies the two requirements of higher thrust per platform area and equal maneuverability (maneuverable Degrees of Freedom (DoF)) as typical quadrotors. The proposed aerial vehicle is mechanically simple, alleviating the need for intricate moving parts that increase the overall mechanical complexity of the aerial vehicle, which decreases the complexity and failure rate.

According to various embodiments, the present disclosure discloses an aerial vehicle system comprising multiple ones of the proposed aerial vehicle. The aerial vehicles may be in independent communication with a control station. The control station may be configured to independently wirelessly control each of the aerial vehicles.

According to various embodiments, the present disclosure also discloses a method of aerial lifting using multiple aerial vehicles. The method of aerial lifting comprises independently controlling each of the aerial vehicle to a respective target position. This may be performed without requiring inter-vehicle communication between the aerial vehicles, thus reducing the complications involved.

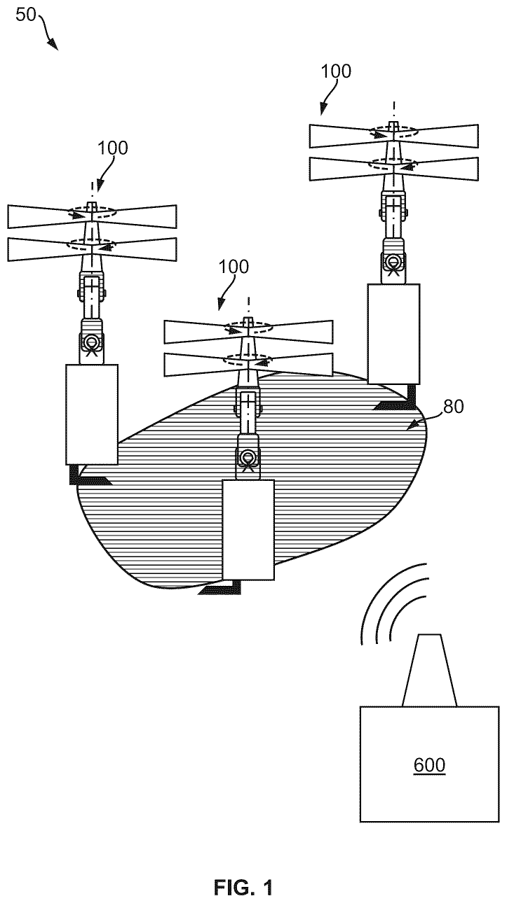

FIG. 1 schematically shows an aerial vehicle system 50 according to various embodiments of the present disclosure. The aerial vehicle system 50 may include multiple aerial vehicles 100 in signal communication with a control station 600. The control station 600 may be configured to independently wirelessly control each of the aerial vehicles 100. In some instances, based on the task, the control station 600 may selectively control one or more aerial vehicles 100 in performing the task. In various embodiments, the aerial vehicle system 50 may be configured to perform a method of aerial lifting of a load 80. The load 80 may be an irregularly shaped object as shown in FIG. 1. The load 80 may also be a regularly shaped object such as a box or a parcel.

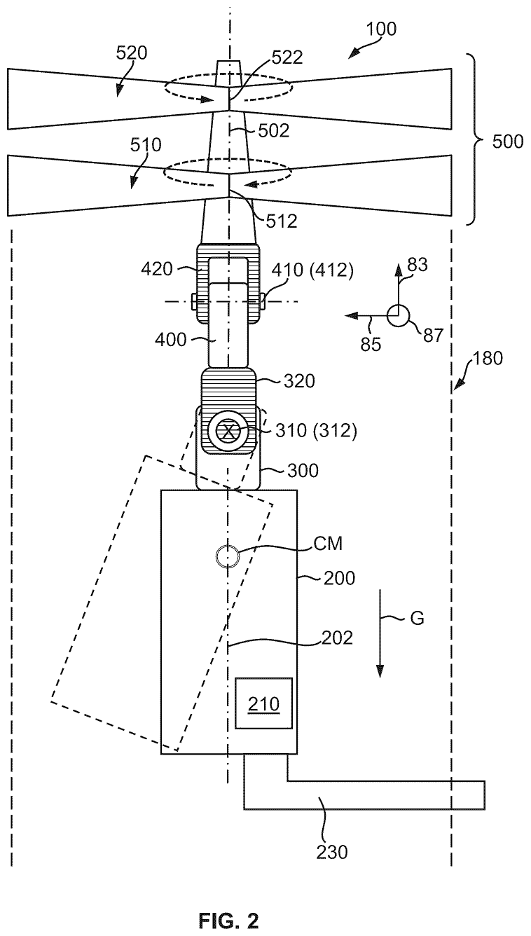

FIG. 2 schematically shows an aerial vehicle 100 according to various embodiments. The aerial vehicle 100 may include a housing 200 or a fuselage of the vehicle. The housing 200 may define a housing axis 202 which passes through a centre of mass (CM) of the housing 200. The housing axis 202 may be defined by one diametrical side of the housing 200, such as a height of the housing 200. In various embodiments, during a vertical flight of the aerial vehicle 100 as shown in FIG. 2, the housing axis 202 may be generally parallel to the gravity direction (G).

In various embodiments, the aerial vehicle 100 may further include a first motor 300 coupled to the housing 200. The first motor 300 may include a first output shaft 310 defining a first output axis 312. According to various embodiments, a first mount 320 may be coupled to the first output shaft 310. The first mount 320 may be angularly displaceable by the first output shaft 310 about the first output axis 312. In various embodiments, an angular position/angular displacement of the first output shaft 310 may be controllably varied. In an exemplary embodiment, the first motor 300 may be a servomotor or a DC motor angularly controllable via pulse width modulation (PWM).

In various embodiments, the aerial vehicle 100 may further include a second motor 400 coupled to the first mount 320. The second motor 400 may include a second output shaft 410 defining a second output axis 412. According to various embodiments, a second mount 420 may be coupled to the second output shaft 410. The second mount 420 may be angularly displaceable by the second output shaft 410 about the second output axis 412. In various embodiments, an angular position/angular displacement of the second output shaft 410 may be controllably varied. In an exemplary embodiment, the second motor 400 may be a servomotor or a DC motor angularly controllable via pulse width modulation (PWM). In various embodiments, each of the first output axis 312 and the second output axis 412 may be orthogonal to the housing axis 202.

In various embodiments, the aerial vehicle 100 may further include a propeller assembly 500 coupled to the second mount 420. The propeller assembly 500 may include a pair of propellers 510/520 coupled to the second mount 420. The pair of propellers 510/520 may include a first propeller 510 rotatable about a first propeller axis 512, and a second propeller 520 rotatable about a second propeller axis 522. The first propeller 510 may rotate in an opposing direction to the second propeller 520. Hence, it may be said that the pair of propellers 510/520 are counter-rotating propellers or contra-rotating propellers. In various embodiments, the pair of propellers 510/520 may be rotatable about a common propeller axis 502 or are coaxially rotatable. In other words, the first propeller axis 512 may be coaxial with the second propeller axis 522.

In alternative embodiments, the first propeller axis 512 may be non-coaxial with the second propeller axis 522. In such instances, the common propeller axis 502 may be defined by an axis equidistance from the first propeller axis 512 and the second propeller axis 522. For example, the first propeller axis 512 may be spaced apart from the second propeller axis 522, the common propeller axis 502 may be defined by an axis passing through a midpoint between the first propeller axis 512 and the second propeller axis 522. In these embodiments, each of the first propeller 510 and the second propeller 520 may be coupled with a respective ball joint.

The aerial vehicle 100 may include a controller 210 disposed in the housing 200. The controller 210 may be in signal communication with each of the first motor 300, the second motor 400, and the propeller assembly 500. In various embodiments, the controller 210 may be wirelessly communicable with a control station disposed remote from the aerial vehicle.

In various embodiments, the pair of propellers 510/520 of the aerial vehicle 100 may define a volumetric thrust stream 180 along the common propeller axis 502. The volumetric thrust stream 180 may generally refers to a volumetric airflow generated by rotations of the propeller(s) 510/520. The volumetric thrust stream 180 may be defined by a respective diameter of one or both of the pair of propellers 510/520 along the common propeller axis 502.

In various embodiments, as shown in FIG. 2, for improvement of stability of the aerial vehicle 100, the centre of mass (CM) of the housing 200 may be disposed interior of the volumetric thrust stream 180. FIG. 2 further shows the housing 200 tilted relative to the gravity direction (G) during flight. It may be seen that during flights, the centre of mass (CM) of the housing 200 remains disposed interior of the volumetric thrust stream 180.

In various embodiments, the aerial vehicle 100 may further include a holder 230 coupled to the housing. Depending on application, the holder 230 may be configured to detachably couple to a load. In various embodiments, the holder 230 may extend exterior of the volumetric thrust stream 180.

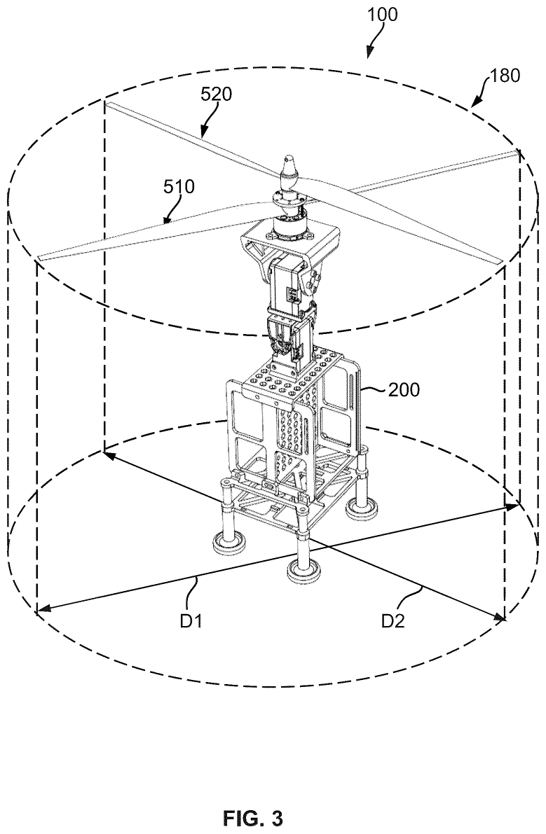

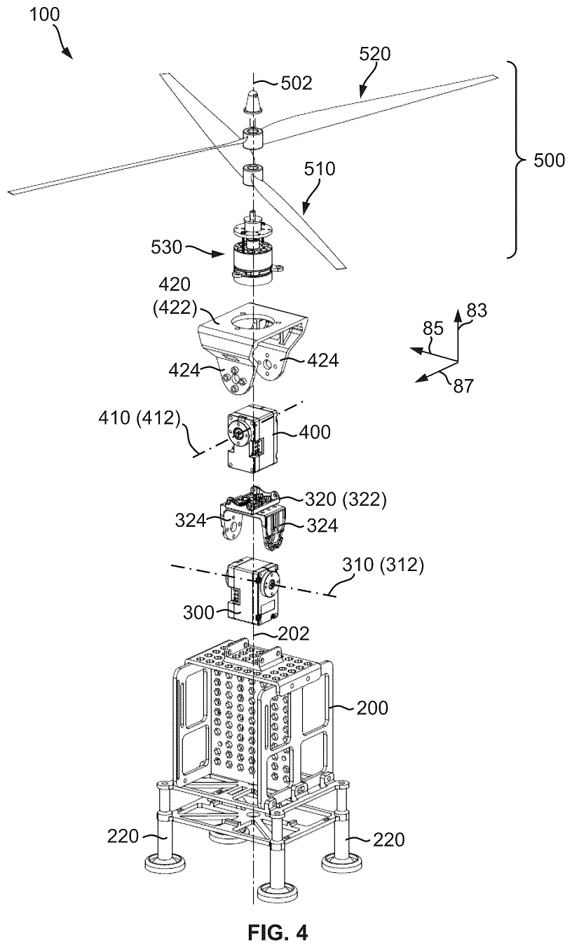

FIGS. 3 and 4 show an aerial vehicle 100 according to various embodiments of the disclosure. The aerial vehicle 100 may include a housing 200 in the form of a frame for weight savings. The housing 200 may further include multiple legs 220 extending from and/or coupled to a bottom surface or first surface of the housing 200. The aerial vehicle 100 may further include printed circuit board(s), controller(s), power source(s) disposed in or coupled to the housing 200. In various embodiments, the controller may be wirelessly communicable with a control station remote from the aerial vehicle.

According to various embodiments, a first motor 300 may be coupled to a top surface or second surface of the housing 200. The second surface may be opposing that of the first surface. The first motor 300 may include a first output shaft 310 defining a first output axis 312. A first mount 320 may be coupled the first output shaft 310. The first motor 300 may be a servomotor configured to angularly displace the first mount 320 about the first output axis 312, by rotating the first output shaft 310. The first mount 320 may be configured in an inverse U-shape comprising a first mounting plate 322 with two extending first arms 324. The two extending first arms 324 may be disposed on opposing ends of the first mounting plate 322. The two extending first arms 324 may be coupled to the first output shaft 310 of the first motor 300, such that a rotation of the first output shaft 310 is transferred to the first mount 320.

In various embodiments, a second motor 400 may be coupled to the first mounting plate 322 of the first mount 320. The second motor 400 may include a second output shaft 410 defining a second output axis 412. A second mount 420 may be coupled the second output shaft 410. The second motor 400 may be a servomotor configured to angularly displace the second mount 420 about the second output axis 412, by rotating the second output shaft 410. In various embodiments, the first output axis 312 and the second output axis 412 are orthogonal to one another. The second mount 420 may be configured in an inverse U-shape comprising a second mounting plate 422 with two extending second arms 424. The two extending second arms 424 may be disposed on opposing ends of the first mounting plate 322. The two extending first arms 324 may be coupled to the second output shaft 410 of the second motor 400, such that a rotation of the second output shaft 410 is transferred to the second mount 420.

In various embodiments, an orientation of the first mount 320 relative to the housing 200 is controllable by the first output shaft 310 solely. In addition, an orientation of the second mount 420 relative to the housing 200 is controllable by the first output shaft 310 and the second output shaft 410 collectively.

In various embodiments, the aerial vehicle 100 may further include a propeller assembly 500 coupled to the second mounting plate 422 of the second mount 420. The propeller assembly 500 may include a first propeller 510 and a second propeller 520 driveable by a propeller actuator 530. The propeller actuator 530 may include a first propeller motor for driving the first propeller 510 about a first propeller axis and a second propeller motor for driving the second propeller about a second propeller axis. The first propeller 510 may rotate in an opposing direction to the second propeller 520. Hence, the first propeller 510 and the second propeller 520 are counter-rotating propellers or contra-rotating propellers.

In various embodiments, the pair of propellers 510/520 may define a common propeller axis 502. The first propeller axis and the second propeller axis may be coaxial with one another, to define a common propeller axis 502. Therefore, the pair of first and second propellers 510/520 may be rotatable about the common propeller axis 502. In other words, the first propeller axis 512 may be coaxial with the second propeller axis 522. In various embodiments, the pair of propellers 510/520 are spaced apart from each other along the common propeller axis 502.

In various embodiments, the first propeller 510 may define a first propeller diameter (D1) and the second propeller 520 may define a second propeller diameter (D2). The first propeller diameter (D1) and the second propeller diameter (D2) may have a common diameter. Alternatively, the first propeller diameter (D1) and the second propeller diameter (D2) may have different diameters.

In various embodiments, the pair of propellers 510/520 of the aerial vehicle 100 may define a volumetric thrust stream 180 along the common propeller axis 502. In an exemplary embodiment, the first propeller diameter (D1) and the second propeller diameter (D2) may define the volumetric thrust stream 180 along the common propeller axis 502. The volumetric thrust stream 180 may generally refers to a volumetric airflow generated by rotations of the propeller(s) 510/520. In various embodiments, for improvement of stability of the aerial vehicle 100, the centre of mass (CM) of the housing 200 may be disposed interior of the volumetric thrust stream 180.

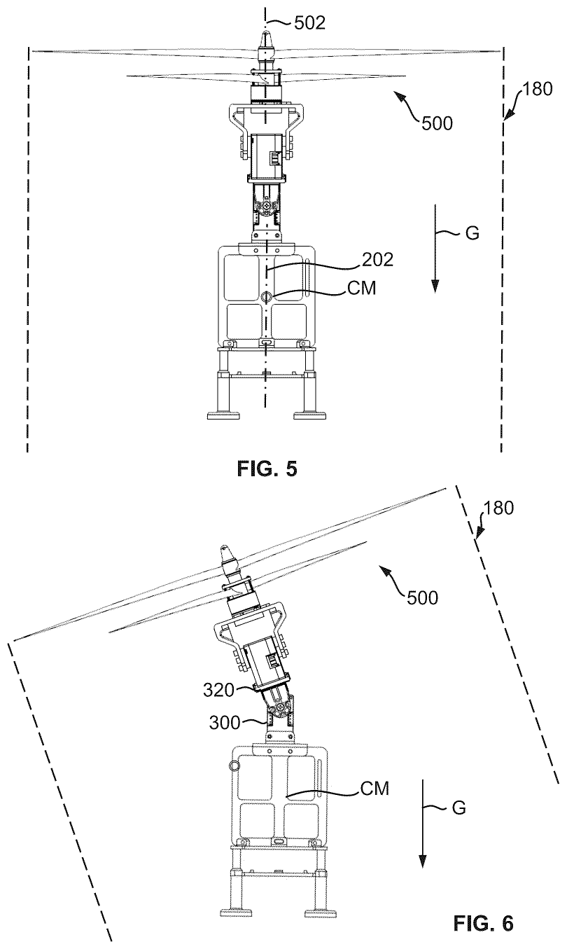

FIG. 5 shows the aerial vehicle 100 in a neutral state according to various embodiments. The neutral state may be defined as a generally vertical state. The neutral state may be defined as a state of the aerial vehicle during vertical take-off. The neutral state may be defined by a stable state wherein the centre of mass (CM) is in line or aligned with the common propeller axis 502. The neutral state may also be defined by the common propeller axis 502 being substantially coaxially aligned with the housing axis 202. In various embodiments, when the aerial vehicle 100 is in the neutral state, the volumetric thrust stream 180 is substantially parallel to the housing axis 202.

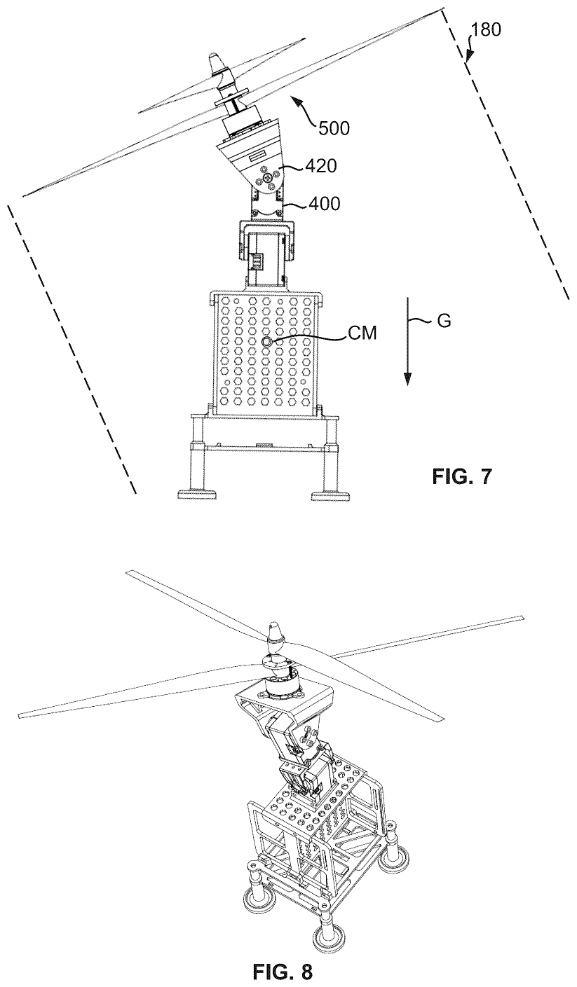

FIGS. 6 and 7 show the aerial vehicle 100 in flight performing a thrust vectoring along a single angular direction. As shown in FIG. 6, the first motor 300 is actuated to displace the first mount 320, and hence indirectly the propeller assembly 500, away from the neutral state (as shown in FIG. 5). Hence, the propeller assembly 500 may be reoriented by actuating the first motor 300 solely. As shown in FIG. 7, the second motor 400 is actuated to displace the second mount 420, and hence indirectly the propeller assembly 500, away from the neutral state (as shown in FIG. 5). Hence, the propeller assembly 500 may be reoriented by actuating the second motor 400 solely.

FIG. 8 shows the aerial vehicle 100 in flight performing a thrust vectoring along two angular directions. As shown in FIG. 8, both the first motor 300 and the second motor 400 are actuated to displace the propeller assembly 500 away from the neutral state (as shown in FIG. 5). While the propeller assembly 500 may be tilted relative to the gravity direction (G) during flight, it may be seen that the centre of mass (CM) of the housing 200 remains disposed interior of the volumetric thrust stream 180 during flight for stability.

It may be understood that a first orientation of the first mount 320 relative to the housing 200 is controllable by the first output shaft of the first motor 300 solely. In addition, a second orientation of the second mount 420 relative to the housing 200 is controllable by the first output shaft and the second output shaft collectively.

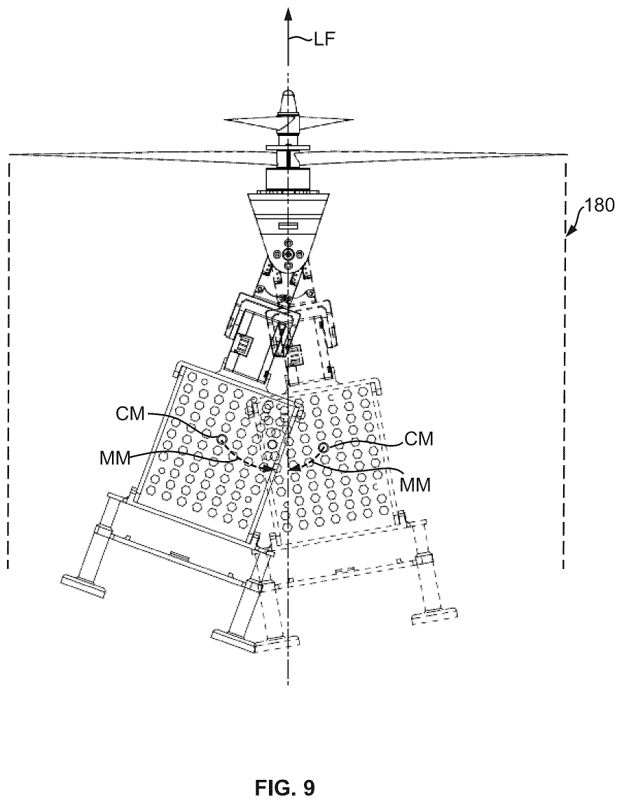

Structural configurations of the proposed aerial vehicle 100 may aid in the stability during flight and simplify the stability control of the aerial vehicle 100. Referring to FIG. 9, during flight, when the aerial vehicle 100 is subjected to a disturbance, such as a turbulent airflow, a counter moment (MM) acting on the centre of mass (CM) of the aerial vehicle 100 may bring the aerial vehicle back towards the neutral state. This is possible due to the pair of propellers (providing the lifting force LF) being spaced apart from the housing 200 along the housing axis 202. This causes a counter moment (MM) to form about the lifting force (LF) location, which acts on the centre of mass (CM).

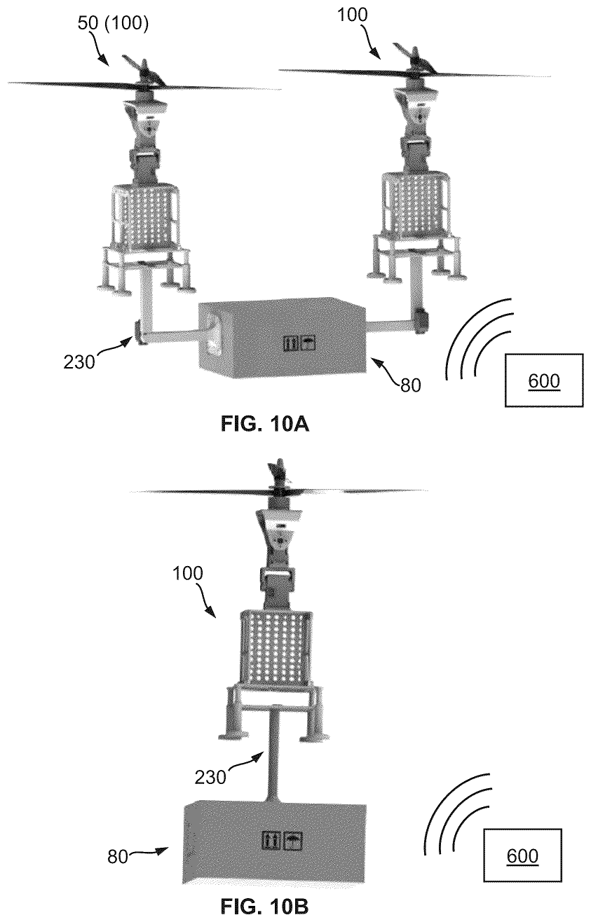

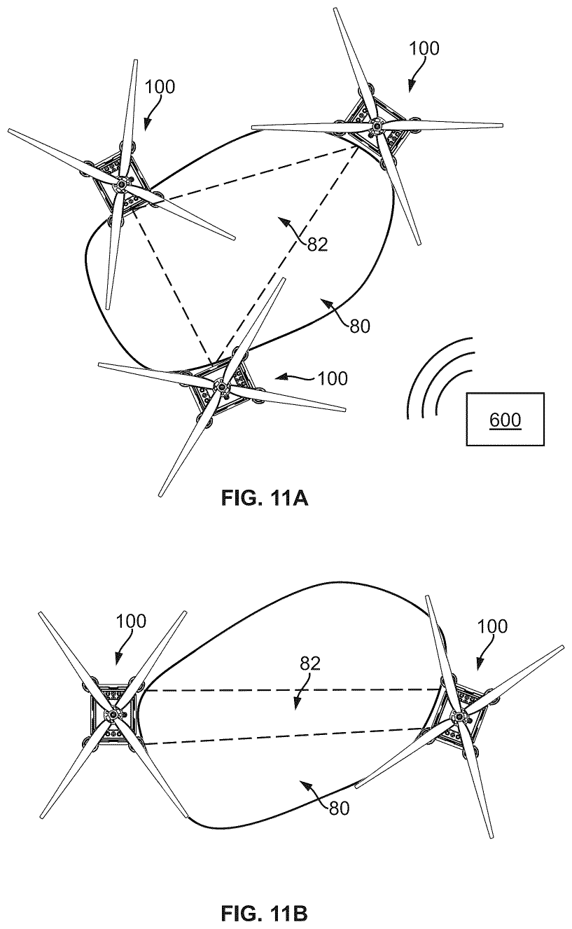

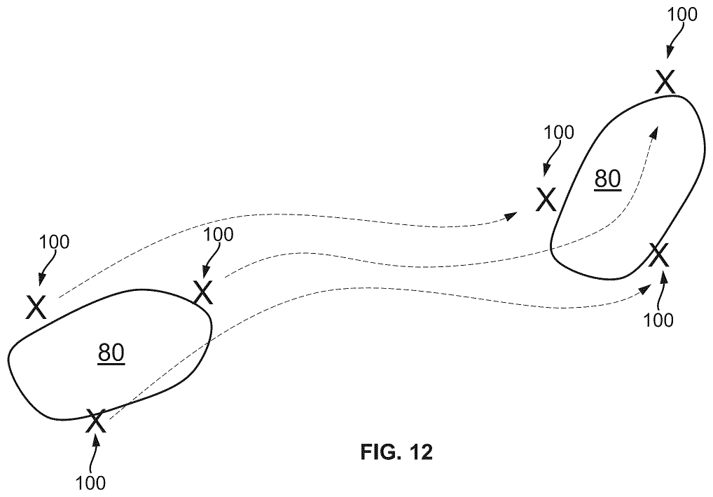

According to another aspect of the disclosure, referring to FIGS. 10A to 11B, disclosed herein an aerial vehicle system 50 for moving a load 80. The aerial vehicle system 50 may include multiple aerial vehicles 100 (as shown in FIG. 10A). Alternatively, the aerial vehicle system 50 may include a single aerial vehicle 100 (as shown in FIG. 10B). The aerial vehicle system 50 may also include a control station 600 being configured to independently wirelessly control each of the aerial vehicles 100. In various embodiments, the control station 600 may selectively control specific ones of the aerial vehicles 100.

In various embodiments, each of the aerial vehicle 100 may include a holder 230 for coupling to the load 80. The load 80 may include multiple coupling points. In various embodiments, the aerial vehicle 100 may detachably couple to one or more of the multiple coupling points on the load 80. As examples, the holder 230 may be an arm, a gripper, an adhesion, a magnetic picker, a vacuum picker, etc. In various embodiments, the multiple coupling points are non-symmetrically and non-uniformly distributed on the load.

In various embodiments, as shown in FIGS. 11A and 11B, the multiple aerial vehicles 100 may define a lifting space 82, wherein the load 80 may be disposed at least partially in the lifting space 82. The aerial vehicle system 50 may be configured to lift or move a load 80 to a target position using the multiple aerial vehicles 100. In various embodiments, the aerial vehicle system 50 may be configured to lift or vary an orientation of a load 80 to a target orientation using the multiple aerial vehicles 100.

According to various embodiments, as shown in FIG. 11A, the control station 600 of the aerial vehicle system 50 may be configured to independently control each of the multiple ones of the aerial vehicle 100. The control station 600 may control each aerial vehicle to detachably couple with a respective coupling point of the load. The control station 600 may further control each aerial vehicle to move to a respective target position to vary a position of the load, wherein each of the respective target position is distinct from one another. In addition, the control station 600 may be further configured to independently control each of the multiple ones of the aerial vehicle 100 to: move to a respective target position to vary an orientation of the load.

In various embodiments, the control station 600 may be configured to determine each of the respective target position based on at least one geometrical dimension of the load 80. For example, determining the target position of each aerial vehicle 100 may take into consideration a width of the load 80 in obstacle avoidance path planning.

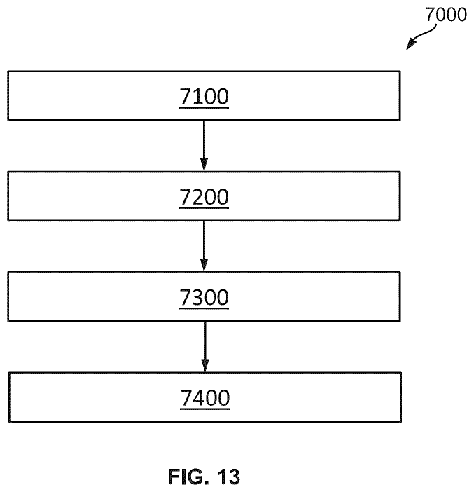

According to another aspect of the disclosure, as shown in FIG. 13, a method of aerial lifting 7000 is disclosed. The method 7000 comprises: in 7100, detachably coupling a plurality of aerial vehicles to a plurality of coupling points of a load; and in 7200, independently controlling each of the aerial vehicle to a respective target position to vary a position of the load, wherein each of the respective target position is distinct from one another. The method 7000 may further include, in 7300, independently controlling each of the aerial vehicle to a respective target position to vary an orientation of the load. In various embodiments, the method may also include in 7400, determining each of the respective target position based on at least one geometrical dimension of the load. In various embodiments, the multiple coupling points are non-symmetrically and non-uniformly distributed across the load.

### Exemplary Embodiment of the Proposed Aerial Vehicle

### Overall Mechanical Structure

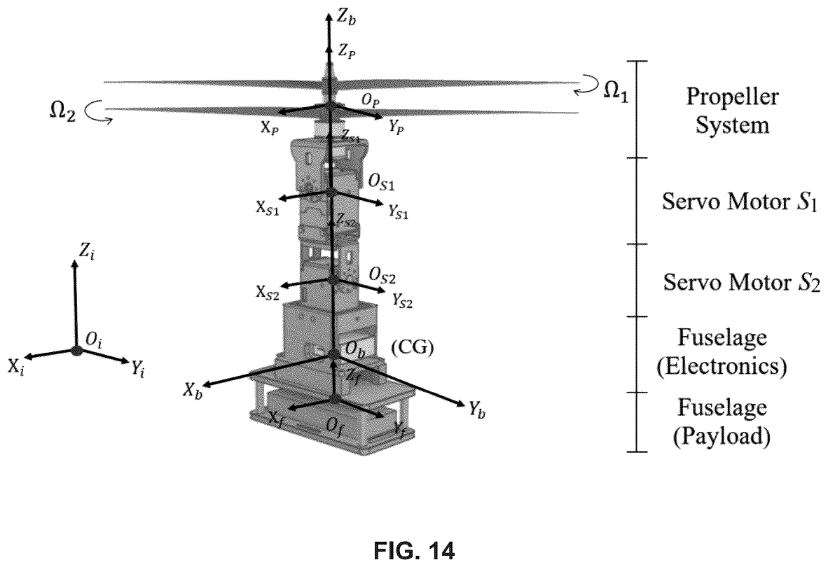

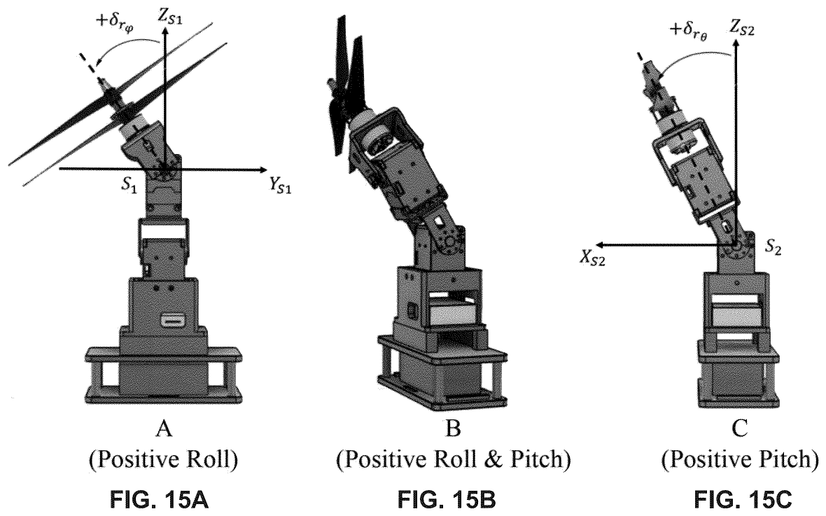

In an exemplary embodiment, the proposed aerial vehicle may be configured as a coaxial drone which comprises one propeller system, two servomotors and one lower fuselage section. The propeller system may be a coaxial propeller system which comprises two counter-rotating rotors powered by a pair of brushless motors that generate necessary thrust for flight. The two servomotors produce localized roll and pitch rotations of the propeller system for thrust vectoring. A series of connecting mounts also provide structural support for the coaxial drone. The drone's fuselage section houses the flight controller, battery, and other electrical components. The components located in the drone's fuselage have a relatively larger mass compared to the servomotors and the propeller, resulting in the center of gravity (CG) of the entire coaxial drone to be located in the fuselage section. It was assumed that the CG of the entire drone is vertically aligned with the CG of the drone's fuselage. A representation of the coaxial drone and its localized rotation angles are shown in FIGS. 14 and 15A to 15C. In addition, since the airflow produced by the propeller system is towards the direction from the propeller to the fuselage, the fuselage part is designed to be as vertical as possible, ensuring minimum obstruction to the airflow.

### Rigid Bodies and Coordinate Frames

As shown in FIG. 14, there are four rigid bodies assembled to form the coaxial drone. Coordinate frames for each of the four rigid bodies were introduced to describe the relative positions in space. The first rigid body consists of the propeller system and its rotation mount. The corresponding frame is represented by Σₚ: Oₚ−XₚYₚZₚ whose Oₚ is fixed to the center of the contra-rotating rotors. The second rigid body consists of the first servomotor S₁ and the rotation mounts attached to its bottom surface. The corresponding frame is represented by Σ_{S1}: O_{S1}−X_{S1}Y_{S1}Z_{S1} with O_{S1} fixed to the center of rotation axis of S₁. In addition, S₁ controls the roll angle δᵣ_{_{φ}} of the first rigid body Oₚ, where a counterclockwise rotation along X_{S1} produces a positive roll (i.e., following the right-hand screw rule). The third rigid body consists of the second servomotor S₂ and its base mount, which is connected to the drone's fuselage. It has a frame of reference Σ_{S2}: O_{S2}−X_{S2}Y_{S2}Z_{S2} with O_{S2} fixed to the center of rotation axis of S₂. Also, S₂ controls the pitch angle δᵣ_{_{θ}} of the second rigid body O_{S1}, where a counterclockwise rotation along Y_{S2} produces a positive pitch. The fourth rigid body refers to the drone's fuselage and its respecting components. It has a body frame Σ_{f}: O_{f}−X_{f}Y_{f}Z_{f} with O_{f} being fixed to the CG of the rigid body.

In the follow-up sections of this present application, two frames are selected as the main reference frames for the modeling of the drone. The first is the inertial coordinate frame Σᵢ: Oᵢ−XᵢYᵢZᵢ fixed to the ground of Earth. The second is the body frame Σ_{b}: O_{b}−X_{b}Y_{b}Z_{b} whose origin O_{b} is rigidly attached to the CG of the coaxial drone (the total mass of the drone is taken to act at this point).

### Connection of Coaxial Propeller, Servomotors, and Fuselage

The coaxial drone has a simple assembly, with its mechanical and electrical components connected in a vertical arrangement. The coaxial propeller system serves as the primary source of thrust for the drone along a common axis. A carefully designed rotation mount provides sufficient clearance for the unobstructed rotation of the propeller by δᵣ_{_{φ}}∈[−90°, 90°], as shown in FIGS. 15A to 15C. A stronger rotation mount is used for the secondary servomotor S2 to support the combined weight of the propeller system and S1. Similarly, FIGS. 15A to 15C also show that a rotation clearance of δᵣ_{_{θ}}∈[−90°, 90°] can be achieved by the subsequent mount in the system, which indicates that the outputted angle range of servomotors is larger than that of swashplates. This dual arrangement of the servomotors allows the drone to perform forward-backward and lateral maneuvers in flight by rotating the direction of the generated thrust. The usage of the angles δᵣ_{_{φ}} and δᵣ_{_{θ}} to maintain flight stability of the drone is explored in the follow-up sections of this present application.

Another consideration for the assembly of the drone is the design of the connecting base mount which is situated between O_{S2} and O_{b} in FIG. 14 attached between the end of S2 and the drone's fuselage. The dimensions of the base mount are designed to allow for a secure connection for ease of assembly and effective transfer of forces. The drone's fuselage consists of two housing frames that contain the flight controller and the battery pack, respectively. All remaining electrical cables and connecting components are stored within the drone's fuselage as well.

Comparison of Thrust Per Platform Area with Quadrotors

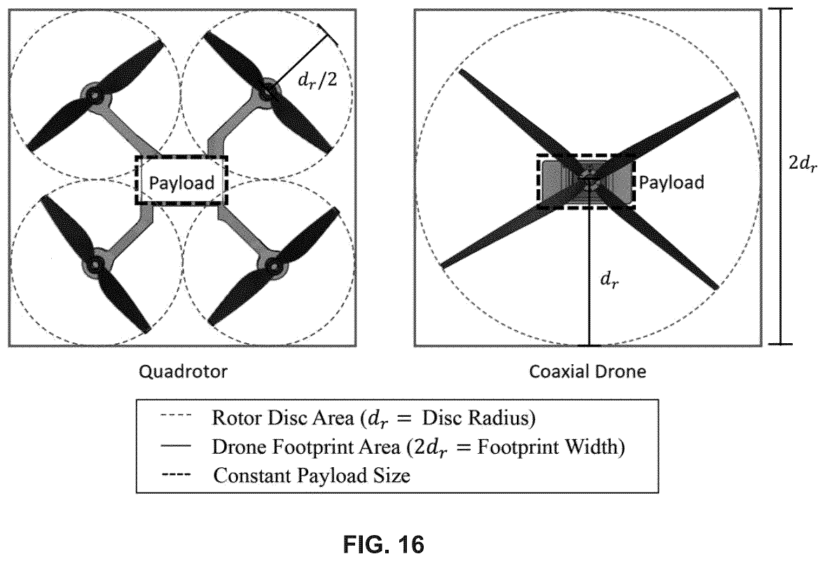

In this section, the maximum thrust per platform area is compared between a conventional quadrotor and the proposed coaxial drone with similar payload capabilities, as shown in FIG. 16. For a fair comparison, both quadrotor and the proposed coaxial drone have a similar/same footprint area (characterized by a square), the same size of payload, the same overall weight, and rotational angular speed. FIG. 16 shows that the radius of the quadrotor's propeller is dᵣ/2, while that of the coaxial drone is dᵣ. Accordingly, the magnitude of thrust generated by one rotor of the quadrotor can be calculated by

$${F}_{propeller 1} = ρ {C}_{T} {π ( \frac{{d}_{r}}{2} )}^{2} {( \frac{ω {d}_{r}}{2} )}^{2} = \frac{ρ {C}_{T} π {ω}^{2} {d}_{r}^{4}}{16} \qquad ( 1 )$$

where ρ is the density of air, C_{T} is the lift coefficient, and ω is the angular velocity of the propeller. Then, the total thrust produced by a quadrotor is F_{quadrotor}=4Fₚᵣₒₚₑₗₗₑᵣ₁=ρC_{T} πω²dᵣ⁴/4. By using similar calculations, the ideal thrust produced by the coaxial drone is F_{coaxial}=2Fₚᵣₒₚₑₗₗₑᵣ₂=2ρC_{T} πω²dᵣ⁴, where Fₚᵣₒₚₑₗₗₑᵣ₂ represents the thrust produced by each propeller in the coaxial drone and the interaction effect between the two propellers is neglected. In practice, the thrust loss caused by the interaction effect is usually between 25% and 35%. Thus, while the maximum thrust loss caused by the interaction effect between the propellers were taken into account, the produced thrust 0.65F_{coaxial}=1.3ρC_{T} πω²dᵣ⁴, of the coaxial drone is still larger than that of the quadrotor. The produced thrust between the coaxial drone and quadrotors are compared in the later experimental section.

In FIG. 16, the footprint of the drone is characterized by a square. If the platform footprint is characterized by a circle instead of a square, then the footprint of the coaxial drone will decrease to πdᵣ², but the footprint of the quadrotor will increase to

$${π ( \frac{1 + \sqrt{2}}{2} {d}_{r} )}^{2}$$

according to the geometric relation. This will further make the coaxial drone's maximum thrust per platform area even larger, and the quadrotor's maximum thrust per platform area even larger, and the quadrotor's maximum thrust per platform area even smaller, as compared to the case of using square footprint.

A drone's real flight-time may be related to many factors, including the drone's equipped battery, mass, size, and mechanical structure. To have a fair comparison of flight-time for different drones, all the factors are to be kept the same, which is difficult since different types of drones have different mass/sensors/components/actuators/batteries.

### Modeling of the Proposed Coaxial Drone

To establish the coaxial drone's position and attitude dynamics, which characterize the relationship between the four control inputs (Ω₁, Ω₂, δᵣ_{_{φ}} and δᵣ_{_{θ}}) and the resulting accelerations with six DoF, referring to the coordinate frames previously introduced. As shown in FIG. 14, the body frame Σ_{b}: O_{b}−X_{b}Y_{b}Z_{b} whose origin O_{b} is rigidly attached to the CG of the coaxial drone, X_{b}-axis points toward the drone's forward direction, Y_{b}-axis points toward the drone's right direction, and Z_{b}-axis follows the right-hand rule which points towards the propeller if δᵣ_{_{φ}}=δᵣ_{_{θ}}=0. The attitude and position dynamics in this modeling are described with respect to the coordinate frame Σᵢ.

### Attitude Kinematics and Dynamics

The attitude of the drone is described by three Euler angles a=[φ, 0, ψ]^{T}∈R³, which characterize the rotation from Σ_{b} to Σᵢ. According to mechanics of rigid bodies, the angular velocity \dot{a} of the drone in Σᵢ can be transformed from Σ_{b} to Σᵢ using the equation

$$\dot{a} = [ \begin{matrix}\dot{ϕ} \\ \dot{θ} \\ \dot{ψ}\end{matrix} ] = [ \begin{matrix}1 & {S}_{ϕ} {T}_{θ} & {C}_{ϕ} {T}_{θ} \\ 0 & {C}_{ϕ} & - {S}_{ϕ} \\ 0 & {S}_{ϕ} sec θ & {C}_{ϕ} sec θ\end{matrix} ] [ \begin{matrix}{ω}_{x b} \\ {ω}_{y b} \\ {ω}_{z b}\end{matrix} ] = \overline{R} {ω}_{b} \qquad ( 2 )$$

where ω_{b}=[ω_{xb}, ω_{yb}, ω_{zb}]^{T}∈R³ represents the angular velocity vector consisting of roll, pitch, and yaw change rates of the drone in Σ_{b}, and R̅ is a three-by-three transformation matrix, and for notation conciseness C: cos, S: sin, T: tan. Then, from (2), one has

$${ω}_{b} = R \dot{a} = {\overline{R}}^{- 1} \dot{a} = [ \begin{matrix}1 & 0 & - {S}_{θ} \\ 0 & {C}_{ϕ} & {S}_{ϕ} {C}_{θ} \\ 0 & - {S}_{ϕ} & {C}_{ϕ} {C}_{θ}\end{matrix} ] \dot{a} . \qquad ( 3 )$$

According to the conservation theorem of angular momentum, one has

$${( \frac{dH}{dt} )}_{i} = {( \frac{dH}{dt} )}_{b} + {ω}_{b} \times {( H )}_{b} \qquad ( 4 )$$

where H∈R³ is the angular momentum of the drone,

$${( \frac{dH}{dt} )}_{i} and {( \frac{dH}{dt} )}_{b}$$

are the time-derivatives of the angular momentum described in Σᵢ and Σ_{b}, respectively, x represents the angular momentum in Σ_{b}. According to the definition of angular momentum, the changing rate of the drone's angular momentum in the inertial frame,

$${( \frac{dH}{dt} )}_{i} = I \ddot{a} ,$$

is equal to the sum of the torque generated from the rotation of the drone's body frame, ω_{b}×(H)_{b}=ω_{b}×Iω_{b}, and the changing rate of the drone's angular momentum in its body frame

$${( \frac{dH}{dt} )}_{b} = {T}_{t}^{b} + {T}_{r}^{b} ,$$

where I∈R^{3×3} is the inertia of the drone which is assumed as a constant matrix, Tₜ^{b}∈R³ and Tᵣ^{b}∈R³ are the applied torques to the CG described in Σ_{b}, which are produced by the coaxial propellers' thrust and rotation, respectively. Then, according to the coaxial drone's mechanical structure in FIG. 14, one has

$${T}_{t}^{b} = {r}_{{F}_{t}} \times {F}_{t}^{b} \qquad ( 5 )$$

where Fₜ^{b}∈R³ is the thrust produced by the propeller system in Σ_{b} whose specific form will be introduced later and r_{F}_{ₜ} is the position vector describing the point of thrust with respect to the reference frame Σ_{b}. It can also be described as the vertical distance of Oₚ with respect to the Σ_{b} which can be derived from a series of transformation from Σ_{S1} and Σ_{S2} to Σ_{b} as shown in the following:

$$\begin{matrix}{O}_{p}^{S 1} = [ \begin{matrix}1 & 0 & 0 \\ 0 & cos {δ}_{{r}_{ϕ}} & - sin {δ}_{{r}_{ϕ}} \\ 0 & sin {δ}_{{r}_{ϕ}} & cos {δ}_{{r}_{ϕ}}\end{matrix} ] [ \begin{matrix}0 \\ 0 \\ {d}_{1}\end{matrix} ] & ( 6 ) \\ {O}_{p}^{S 2} = [ \begin{matrix}cos {δ}_{{r}_{θ}} & 0 & sin {δ}_{{r}_{θ}} \\ 0 & 1 & 0 \\ - sin {δ}_{{r}_{θ}} & 0 & cos {δ}_{{r}_{θ}}\end{matrix} ] [ [ \begin{matrix}\begin{matrix}0 \\ 0\end{matrix} \\ {d}_{2}\end{matrix} ] + {O}_{p}^{S 1} ] & ( 7 ) \\ {r}_{{F}_{t}} = [ \begin{matrix}\begin{matrix}0 \\ 0\end{matrix} \\ {d}_{3}\end{matrix} ] + {O}_{p}^{S 2} = [ \begin{matrix}( {d}_{1} cos {δ}_{{r}_{ϕ}} + {d}_{2} ) sin {δ}_{{r}_{θ}} \\ - {d}_{1} sin {δ}_{{r}_{ϕ}} \\ ( {d}_{1} cos {δ}_{{r}_{ϕ}} + {d}_{2} ) cos {δ}_{{r}_{θ}} + {d}_{3}\end{matrix} ] & ( 8 )\end{matrix}$$

where d₁ is the absolute distance from Oₚ to S₁, d₂ is the absolute distance from S₁ to S₂, and d₃ is the absolute distance from S₂ to O_{b}. Note that (7) and (8) represent the coordinate transformations required to account for the roll and pitch rotations along the X_{S1}- and Y_{S2}-axis, respectively. A final translation of d₃ along the direction Z_{b} in (8) produces the position vector r_{F}_{ₜ} with respect to the reference frame Σ_{b}. Also, the control torque induced by the rotation of the contra-rotating propellers can be described as

$${T}_{r}^{b} = σ ( {γ}^{1} {Ω}_{1}^{2} - {γ}^{2} {Ω}_{2}^{2} ) [ \begin{matrix}{S}_{{δ}_{{r}_{θ}}} {C}_{{δ}_{{r}_{ϕ}}} \\ - {S}_{{δ}_{{r}_{ϕ}}} \\ {C}_{{S}_{{r}_{ϕ }}} {C}_{{δ}_{{r}_{θ}}}\end{matrix} ] \qquad ( 9 )$$

where γ₁∈R⁺ and γ₂∈R⁺ are the lumped moment coefficients of the upper and lower propellers, respectively, and 0<σ<1 is the aerodynamic efficiency factor due to the existence of airflow interactions, and Ω₁∈R, Ω₂∈R are the upper and lower propellers' numbers of revolution per minute. Summarizing (2)-(9) yields the drone's overall attitude dynamics

$$I \ddot{a} = {T}_{t}^{b} + {T}_{r}^{b} + {( R \dot{a} )}^{\times } IR \dot{a} \qquad ( 10 )$$

where for an arbitrary vector

$$x = {[ \begin{matrix}{x}_{1} , & {x}_{2} , & {x}_{3}\end{matrix} ]}^{⊤} ∈ {R}^{3} , {x}^{\times } := [ \begin{matrix}0 & - {x}_{3} & {x}_{1} \\ {x}_{3} & 0 & - {x}_{1} \\ - x & {x}_{1} & 0\end{matrix} ] .$$

Note that according to the symmetric structure of the drone under δᵣ_{_{ϕ}}=δᵣ_{_{θ}}=0, the inertia matrix can be approximately calculated as I=diag(Iₓₓ, I_{yy}, I_{zz}) where Iₓₓ∈R⁺, I_{yy}∈R⁺, I_{zz}∈R⁺ are the inertia along the X, Y, Z-axes of the drone's Σ_{b}, respectively.

### Position Kinematics and Dynamics

Denote the position vector of the drone in Σᵢ as p:=[x₁, x₂, x₃]^{T}∈R³. According to mechanics of rigid bodies, the linear velocity \dot{p} of the drone in Σᵢ can be calculated by using the equation

$$\dot{p} = [ \begin{matrix}\dot{x} \\ \dot{y} \\ \dot{z}\end{matrix} ] \overline{M} {v}_{b} = \overline{M} [ \begin{matrix}{v}_{b x} \\ {v}_{b y} \\ {v}_{b z}\end{matrix} ] \qquad ( 11 )$$

where v_{b}∈R³ is the linear velocity described in Σ_{b}, and M̅ is a three-by-three transformation matrix that can be written as

$$\overline{M} = [ \begin{matrix}{C}_{θ} {C}_{ψ} & {S}_{ϕ} {S}_{θ} {C}_{ψ} - {C}_{ϕ} {S}_{ψ} & {C}_{ϕ} {S}_{θ} {C}_{ψ} + {S}_{ϕ} {S}_{ψ} \\ {C}_{θ} {S}_{ψ} & {S}_{ϕ} {S}_{θ} {C}_{ψ} + {C}_{ϕ} {C}_{ψ} & {C}_{ϕ} {S}_{θ} {S}_{ψ} - {S}_{ϕ} {C}_{ψ} \\ - {S}_{θ} & {S}_{ϕ} {C}_{θ} & {C}_{ϕ} {C}_{θ}\end{matrix} ] . \qquad ( 12 )$$

Then, it is straightforward that v_{b} can be calculated by

$${v}_{b} = {\overline{M}}^{- 1} \dot{p} = M \dot{p} \qquad ( 13 )$$

Then, where M=M̅⁻¹. According to the Newton's second law, one can derive the position dynamics of the drone as

$${m ( \frac{dv}{d t} )}_{i} = {m ( \frac{dv}{d t} )}_{b} + m ( {ω}_{b} \times {ν}_{b} ) \qquad ( 14 )$$

where the total force acting on the drone in the inertial frame is the sum of the forces acting on the drone in its body frame and the centripetal forces from the rotation of the body frame, v∈R³ represents the velocity of the drone, and

$${( \frac{dv}{d t} )}_{i} and {( \frac{dv}{d t} )}_{b}$$

are the accelerations of the drone described in Σᵢ and Σ_{b}, respectively. Note that the component

$${m ( \frac{dv}{d t} )}_{b}$$

in (14) represents the applied force described in Σ_{b} of the drone, which consists of two components, i.e.,

$${m ( \frac{dv}{d t} )}_{b} = {F}_{t}^{b} + {F}_{g}^{b} \qquad ( 15 )$$

where Fₜ^{b}∈R³ is the thrust from the propellers, and F_{g}^{b}∈R³ is the gravity component, of which both are described in Σ_{b}. The aim is to obtain the specific forms for these components. First, the thrust from the propellers can be described with respect to Σₚ as

$${F}_{{t}_{p}} = [ \begin{matrix}0 \\ 0 \\ σ ( {αΩ}_{1}^{2} + {βΩ}_{2}^{2} )\end{matrix} ] ,$$

where α∈R⁺ and β∈R⁺ are the lumped thrust coefficients of the upper and lower propellers, respectively. Thereafter, transfer Fₜ_{ₚ} from Σₚ to Σ_{b} to obtain Fₜ^{b}. According to the geometric relationship in FIGS. 15A-15C, one has

$${F}_{t}^{b} = σ ( {αΩ}_{1}^{2} + {βΩ}_{2}^{2} ) [ \begin{matrix}{S}_{{δ}_{{r}_{θ}}} {C}_{{δ}_{{r}_{ϕ}}} \\ - {S}_{{δ}_{{r}_{ϕ}}} \\ {C}_{{δ}_{{r}_{θ}}} {C}_{{δ}_{{r}_{ϕ}}}\end{matrix} ] . \qquad ( 16 )$$

According to FIGS. 15A-15C, the gravity component of the drone described in Σ_{b} is

$${F}_{g}^{b} = M [ \begin{matrix}\begin{matrix}0 \\ 0\end{matrix} \\ - m g\end{matrix} ] = - m g [ \begin{matrix}- sin θ \\ cos θsinϕ \\ cos θcos ϕ\end{matrix} ] . \qquad ( 17 )$$

Summarizing (11)-(17) yields the drone's overall position dynamics

$$\begin{matrix}m \ddot{p} = {F}_{t}^{b} + {F}_{g}^{b} + m {ω}_{b}^{\times } M \dot{p} \\ = {F}_{t}^{b} + {F}_{g}^{b} + {m ( R \dot{a} )}^{\times } M \dot{p}\end{matrix} \qquad ( 18 )$$

where M defined in (13) is always nonsingular, which makes (18) well-defined.

### Analysis of the Overall Six DoF Dynamics

From the previous section, the overall attitude and position dynamics can be written in a compact form as

$$\{ \begin{matrix}I \ddot{a} - {T}_{t}^{b} - {T}_{r}^{b} - {( R \dot{a} )}^{\times } IR \dot{a} = 0 \\ m \ddot{p} - {F}_{t}^{b} - {F}_{g}^{b} - m ( R \dot{a} ) \times M \dot{p} = 0\end{matrix} \qquad ( 19 )$$

Now, the properties of the overall dynamics (19) were analyzed, which will be the foundation for the control design.

1) Underactuated Dynamics: In the overall nonlinear dynamics (19), the states [a^{T}, p^{T}]^{T}∈R⁶ are six dimensions. However, the control input [Ω₁², Ω₂², δᵣ_{_{θ}}, δᵣ_{_{ϕ}}]∈R⁴ is only four dimensions, which implies an underactuated dynamics. Therefore, only four states are fully controlled. As similar to the quadrotor case, the three DoF positions and yaw angle are usually more important in many applications. Therefore, the three DoF positions and yaw angle are selected as the four controllable states, and firstly leave roll and pitch angles as uncontrollable states.

2) Coupling Effect: The attitude dynamics in (19) are independent to the position dynamics, while the position dynamics are coupled with the attitude dynamics due to the existence of the component m(R\dot{a})×M\dot{p}. Due to the absence of an attitude damping part in (10), the attitude dynamics are naturally unstable in the sense that given a nonzero initial state, the attitude may diverge or oscillate without external control torques. This can be verified by linearizing the attitude dynamics around the equilibrium \dot{a}=0. Thus, additional damping components are needed to stabilize the attitude dynamics. In addition, due to the existence of the gravity component F_{g}^{b} in the position dynamics, the control force Fₜ^{d} should not be zero even at a stable state.

3) Model Accuracy: In this model, the drone has been designed such that its CG lies at the center of its fuselage section. This design specification can be achieved by moving the heavier components in the drone into the fuselage section. In addition, according to the later simulation and experiments, the drone keeps almost vertical during hovering and slowly maneuvering missions, for which the current modeling based on static CG can be used in many scenarios.

Comparison of Overall Dynamics with Quadrotors

A complete comparison between the proposed coaxial drone and quadrotors were compared from the perspective of motion dynamics. By letting the common parameters be the same, such as the air density ρ and the drones' mass m, Table I summarizes the main differences between these two types of drones. According to Table I, the produced thrust along roll or pitch axis is obtained by projecting the overall thrust to the roll or pitch axis. Therefore, under the common parameters and allowed tilting angles, the coaxial drone's thrust along the roll or pitch axis is larger than the corresponding one produced by quadrotors. In addition, to accelerate along the pitch axis, quadrotors need to adjust their attitudes to incline first, then use the projected thrust to produce the desired motion in the pitch axis. Different from quadrotors, the coaxial drone can produce the thrust along the pitch axis directly by tilting the lower servomotor, which is also shown in Table I's second line from the bottom.

TABLE I
Comparison of the coaxial drone and quadrotors

| | Drone | |
|---|---|---|
| Property | Coaxial drone | Quadrotors |
| Translational dynamics | m\ddot{p} − Fₜ^{b} − F_{g}^{b} − | m\ddot{p} + mge_{z} = |
| | m(R\dot{a})^{×} M\dot{p} = 0 | R_{b}ⁱFₜ^{b} |
| Rotational dynamics | Iä − Tₜ^{b} − Tᵣ^{b} − (R\dot{a})^{×} IR\dot{a} = 0 | Jä + C(a, \dot{a})\dot{a} = Tₜ^{b} |
| Control inputs | Ω₁, Ω₂, δᵣ_{_{ϕ}}, δᵣ_{_{θ}} | ω₁, ω₂, ω₃, ω₄ |
| Produced thrust along yaw axis | $2 ρ {C}_{T} π {ω}^{2} {d}_{r}^{4} \times {C}_{{δ}_{{r}_{θ}}} {C}_{{δ}_{{r}_{ϕ}}}$ | ρC_{T}πω²dᵣ⁴/4 × C_{ϕ}C_{θ} |
| Produced thrust along roll axis | $2 ρ {C}_{T} π {ω}^{2} {d}_{r}^{4} \times {C}_{{δ}_{{r}_{θ}}} {S}_{{δ}_{{r}_{ϕ}}}$ | $\frac{ρ {C}_{T} π {ω}^{2} {d}_{r}^{4}}{4} \times ( {C}_{ϕ} {S}_{θ} {C}_{ψ} + {S}_{ϕ} {S}_{ψ} )$ |
| Produced thrust along pitch axis | $2 ρ {C}_{T} π {ω}^{2} {d}_{r}^{4} \times {S}_{{δ}_{{r}_{ϕ}}}$ | $\frac{ρ {C}_{T} π {ω}^{2} {d}_{r}^{4}}{4} \times ( {C}_{ϕ} {S}_{θ} {C}_{ψ} - {S}_{ϕ} {C}_{ψ} )$ |
| Produced force in body frame (Fₜ^{b}) | $σ ( {αΩ}_{1}^{2} + {βΩ}_{2}^{2} ) \times [ \begin{matrix}{S}_{{δ}_{{r}_{θ}}} {C}_{{δ}_{{r}_{ϕ}}} \\ - {S}_{{δ}_{{r}_{ϕ}}} \\ {C}_{{δ}_{{r}_{θ}}} {C}_{{δ}_{{r}_{ϕ}}}\end{matrix} ]$ | $[ \begin{matrix}0 \\ 0 \\ c {\sum }_{i = 1}^{4} {ω}_{i}^{2}\end{matrix} ]$ |
| Produced torque in body frame (Tₜ^{b}) | $σ ( {γ}_{1} {Ω}_{1}^{2} + {γ}_{2} {Ω}_{2}^{2} ) \times [ \begin{matrix}{S}_{{δ}_{{r}_{θ}}} {C}_{{δ}_{{r}_{ϕ}}} \\ - {S}_{{δ}_{{r}_{ϕ}}} \\ {C}_{{δ}_{{r}_{ϕ}}} {C}_{{δ}_{{r}_{θ}}}\end{matrix} ]$ | $[ \begin{matrix}c ( {ω}_{1}^{2} - {ω}_{3}^{2} ) \\ c ( {ω}_{2}^{2} - {ω}_{4}^{2} ) \\ \overline{c} ( {ω}_{1}^{2} - {ω}_{2}^{2} + {ω}_{3}^{2} - {ω}_{4}^{2} )\end{matrix} ]$ |

### Control of the Coaxial Drone

The aim is to control p and ω using Ω₁², Ω₂², δᵣ_{_{θ}}, δᵣ_{_{ϕ}}. Due to the high nonlinear property of the dynamics (19), a desired control force and yaw torque were proposed to stabilize p and ω, then allocate the desired control force and yaw torque to the four real control inputs.

### Desired Control Input

For the attitude dynamics, consider a desired yaw angle ω^{d}(t)∈R, which is continuous and twice differentiable. Then, to make ω(t) track ω^{d}(t), the desired control yaw torque can be designed as

$${T}_{ψ d} = - {[ \begin{matrix}0 \\ 0 \\ 1\end{matrix} ]}^{⊤} {( R \dot{a} )}^{\times } IR \dot{a} + {I}_{zz} [ {\ddot{ψ}}^{d} - {k}_{d} ( \dot{ψ} - {\dot{ψ}}^{d} ) - {k}_{p} ( ψ - {ψ}^{d} ) ] \qquad ( 20 )$$

where k_{d}>0, kₚ>0 are velocity feedback and state feedback gains, respectively.

For the position dynamics, consider a desired flight trajectory p^{d}(t)∈R³, which is continuous and twice differentiable. Then, based on the fully actuated system approaches, the desired control force can be designed as

$${F}_{d} = - {F}_{g}^{b} - {m ( R \dot{a} )}^{\times } M \dot{p} + m [ {\ddot{p}}^{d} - {k}_{d} ( \dot{p} - {\dot{p}}^{d} ) - {k}_{p} ( p - {p}^{d} ) ] \qquad ( 21 )$$

For the coaxial drone whose dynamics are modeled as (19), if the control inputs Ω₁², Ω₂², δᵣ_{_{θ}}, δᵣ_{_{ϕ}} are designed such that

$$[ 0 , 0 , 1 ] ( {T}_{t}^{b} + {T}_{r}^{b} ) = {T}_{ψ d} , {F}_{t}^{b} = {F}_{d} \qquad ( 22 )$$

then the position error \tilde{p}(t)=p(t)−p^{d}(t) and yaw angle error \tilde{ψ}(t)=ψ(t)−ψ^{d}(t) converge to zero.

Substituting the controllers (20)-(22) into the overall dynamics (19) yields

$$\{ \begin{matrix}m {p}^{\ddot{\sim}} ( t ) + m {k}_{d} {p}^{\dot{\sim}} ( t ) + m {k}_{p} \tilde{p} ( t ) = 0 \\ {I}_{zz} {ψ}^{\ddot{\sim}} ( t ) + {I}_{zz} {k}_{d} {ψ}^{\dot{\sim}} ( t ) + {I}_{zz} {k}_{p} \tilde{ψ} ( t ) = 0\end{matrix} . \qquad ( 23 )$$

Since m>0 and I_{zz}>0, the characteristic polynomial of the linear dynamics (23) can be written as

$${s}^{2} + {k}_{d} s + {k}_{p} = 0 \qquad ( 24 )$$

where s∈C. Since k_{d}>0 and kₚ>0, \tilde{p}(t) and \tilde{ψ}(t) converge to zero.

### Control Allocation

Note that the above relies on the assumption that (22) should hold. In this section, viability of the control inputs Ω₁², Ω₂², δᵣ_{_{θ}}, δᵣ_{_{ϕ}} such that (22) was investigated, which is inherently a control allocation problem.

First, substituting the definitions of Tₜ^{d} and Tᵣ^{b} in (5)-(9) into (22) yields

$${T}_{ψ d} = σ [ {C}_{{δ}_{{r}_{θ}}} {C}_{{δ}_{{r}_{ϕ}}} ( {γ}_{1} {Ω}_{1}^{2} - {γ}_{2} {Ω}_{2}^{2} ) + {d}_{2} {S}_{{δ}_{{r}_{θ}}} {S}_{{δ}_{{r}_{ϕ}}} ( α {Ω}_{1}^{2} + {βΩ}_{2}^{2} ) ] . \qquad ( 25 )$$

Then, substituting the definition of Fₜ^{d} in (16) into (22) yields

$${F}_{d} ( 1 ) = σ {S}_{{δ}_{{r}_{θ}}} {C}_{{δ}_{{r}_{ϕ}}} ( α {Ω}_{1}^{2} + {βΩ}_{2}^{2} ) \qquad ( 26 )$$

$${F}_{d} ( 2 ) = - σ {S}_{{δ}_{{r}_{ϕ}}} ( α {Ω}_{1}^{2} + β {Ω}_{2}^{2} ) \qquad ( 27 )$$

$${F}_{d} ( 3 ) = σ {C}_{{δ}_{{r}_{θ}}} {C}_{{δ}_{{r}_{ϕ}}} ( {αΩ}_{1}^{2} + β {Ω}_{2}^{2} ) . \qquad ( 28 )$$

Note that T_{ψd}, F_{d}(1), F_{d}(2), F_{d}(3) are known from the righthand side of (20) and (21). Therefore, there is a need to find a unique mapping from Ω₁², Ω₂², δᵣ_{_{θ}}, δᵣ_{_{ϕ}} from T_{ψd}, F_{d}(1), F_{d}(2), F_{d}(3) such that (25)-(28) holds.

Different from linearization-based control approach, a precise nonlinear control allocation approach is proposed and disclosed herein. Dividing (26) by (28) yields

$${δ}_{{r}_{θ}} = arctan \frac{{F}_{d} ( 1 )}{{F}_{d} ( 3 )} \qquad ( 29 )$$

Dividing (27) by (28) yields

$${δ}_{{r}_{ϕ}} = - arctan \frac{{F}_{d} ( 2 ) {C}_{{δ}_{{r}_{θ}}}}{{F}_{d} ( 3 )} \qquad ( 30 )$$

where

$${C}_{{δ}_{{r}_{θ}}}$$

can be known from (29). After the knowledge of δᵣ_{_{θ}} and δᵣ_{_{ϕ}}, (28) can be rewritten as

$$α {Ω}_{1}^{2} + β {Ω}_{2}^{2} = \frac{{F}_{d} ( 3 )}{σ {C}_{{δ}_{{r}_{θ}}} {C}_{{δ}_{{r}_{ϕ}}}} . \qquad ( 31 )$$

Substituting (31) into (25) yields

$${γ}_{1} {Ω}_{1}^{2} - {γ}_{2} {Ω}_{2}^{2} = \frac{{T}_{ψ d} {C}_{{δ}_{{r}_{θ}}} {C}_{{δ}_{{r}_{ϕ}}} - {F}_{d} ( 3 ) {d}_{2} {S}_{{δ}_{{r}_{θ}}} {S}_{{δ}_{{r}_{ϕ}}}}{σ {C}_{{δ}_{{r}_{θ}}}^{2} {C}_{{δ}_{{r}_{ϕ}}}^{2}} . \qquad ( 32 )$$

Combining (31) and (32) yields

$${Ω}_{1}^{2} = \frac{{γ}_{2} {F}_{d} ( 3 ) {C}_{{δ}_{{r}_{θ}}} {C}_{{δ}_{{r}_{ϕ}}} + β {T}_{ψ d} {C}_{{δ}_{{r}_{θ}}} {C}_{{δ}_{{r}_{ϕ}}} - β {F}_{d} ( 3 ) {d}_{2} {S}_{{δ}_{{r}_{θ}}} {S}_{{δ}_{{r}_{ϕ}}}}{σ {C}_{{δ}_{{r}_{θ}}}^{2} {C}_{{δ}_{{r}_{ϕ}}}^{2} ( {αγ}_{2} + {βγ}_{1} )} \qquad ( 33 )$$

$${Ω}_{2}^{2} = \frac{{γ}_{1} {F}_{d} ( 3 ) {C}_{{δ}_{{r}_{θ}}} {C}_{{δ}_{{r}_{ϕ}}} - α {T}_{ψ d} {C}_{{δ}_{{r}_{θ}}} {C}_{{δ}_{{r}_{ϕ}}} - α {F}_{d} ( 3 ) {d}_{2} {S}_{{δ}_{{r}_{θ}}} {S}_{{δ}_{{r}_{ϕ}}}}{σ {C}_{{δ}_{{r}_{θ}}}^{2} {C}_{{δ}_{{r}_{ϕ}}}^{2} ( {αγ}_{2} + {βγ}_{1} )} \qquad ( 34 )$$

The control allocation steps are summarized as the following results.

Given the desired yaw torque T_{ψd} and force F_{d} and the relationship (25)-(28), the four control inputs can be uniquely allocated using (29), (30), (33), and (34). Moreover, the coaxial drone is commanded according to (29), (30), (33), and (34), the tracking errors \tilde{p}(t)=p(t)−p^{d}(t) and \tilde{ψ}(t)=ψ(t)−ψ^{d}(t) converge to zero.

In (29), (30), (33), and (34), due to the existence of denominator parts in the calculations of the control inputs Ω₁², Ω₂², δᵣ_{_{θ}}, δᵣ_{_{ϕ}}, it is very important that the calculation of (29), (30), (33), and (34) should not have singularities. Since the drone's gravity force needs to be canceled by F_{d}(3), the magnitude of F_{d}(3) will be sufficiently away from zero, which makes the calculation (29)-(30) singularity-free. Also, the desired tilt angles will be zero when the drone is hovering and be bound when the drone is maneuvering, which makes the calculation (33) and (34) also singularity-free.

### Damping Uncontrolled Roll and Pitch Dynamics

After the position and yaw angle of the drone are controlled to track the desired trajectory and yaw angle, the dynamics of the roll and pitch angles will be fully uncontrolled and evolve according to (19). According to (20) and (21), the divergence of the roll and pitch angular velocities will also make the whole system divergent since both T_{ψd} and F_{d} will become infinite, thus making Ω₁², Ω₂², δᵣ_{_{θ}}, δᵣ_{_{ϕ}} also infinite. Therefore, to avoid this scenario, suppressing the roll and pitch angular velocities is crucial.

It was noted that the vibration of the roll and pitch angles of the drone originates from the actions applied to the two tilt servomotors. Therefore, a natural solution is to add roll and pitch damping components into the corresponding servomotors. More specifically, instead of commanding the two servomotors according to (29) and (30), the two servomotors were commanded by

$${δ}_{{r}_{θ}} = arctan \frac{{F}_{d} ( 1 )}{{F}_{d} ( 3 )} + {k}_{θ} \dot{θ} \qquad ( 35 )$$

$${δ}_{{r}_{ϕ}} = - arctan \frac{{F}_{d} ( 2 ) {C}_{{δ}_{{r}_{θ}}}}{{F}_{d} ( 3 )} + {k}_{ϕ} \dot{ϕ} \qquad ( 36 )$$

where k_{θ} and k_{φ} are gain scalars, which can be tuned according to the performance of experimental tests. The next simulation and experimental sections illustrate the damping components in (35) and (36) being very efficient to stabilize the uncontrolled roll and pitch angular velocities.

Different from conventional controller where the linearization technique is used to analyze the closed loop dynamics, the proposed controller uses a model-based control allocation approach, where linearization is not needed. Also, different from the nonlinear control approaches for coaxial drones, a novel nonlinear control allocation-based approach is proposed for the designed coaxial drone.

There are four control gains kₚ, k_{d}, k_{θ}, k_{φ} in the proposed controllers (20), (21), (35), and (36). Indeed, different selection of control gains will give different system performance, for which the gain parameters was tuned in the experiments. Since the position and attitude dynamics (19) are second-order, the system performance may not be the best if the gains are too large or small. In addition, the two servomotors' updating frequency also determines the system performance, where the difference is that the performance is usually better given larger updating frequency.

For the proposed controllers, referring to Equations (20), (35), and (36), the angular velocities in roll, pitch, and yaw axes are needed, which are usually noisy if such data are obtained from a pure inertial measurement unit (IMU). To improve IMUs' measuring accuracy and reducing noise's magnitude, many auxiliary measurements and techniques have been developed, such as the sensor fusion based on magnetic measurements and advanced digital filtering techniques. Therefore, the angular velocities with relatively small magnitude of noise may be obtained from these IMUs. In addition, from the dynamics of the drone, (19) indicates that the system performance depends on the control laws' PD gain parameters, the damping gains, and the updating frequency of the servomotors, etc. Therefore, by experimental tests, there is a need to choose better control gains to mitigate the negative effect of measurement noises.

### Numerical Simulations

In this section, two types of simulations were conducted, namely mathematical model simulation and physical model simulation, to verify the established model and validate the effectiveness of the proposed control strategy. The related parameters of an actual manufactured coaxial drone are listed in the following, which are also used in all the simulation examples in this section: mass m=652.3 g, d₁=67.1 mm, d₂=67.2 mm, d₃=46.6 mm, and inertial matrix

$$I = [ \begin{matrix}5.83 \times {10}^{6} & 0 & 0 \\ 0 & 5.64 \times {10}^{6} & 0 \\ 0 & 0 & 3.79 \times {10}^{5}\end{matrix} ] g . {mm}^{2}$$

(obtained from the Solidworks software), γ₁=0.000182, γ₂=0.000207, α=0.01227, β=0.01261, and σ=0.673387 (obtained from experiments). The damping gains are selected as k_{θ}=0.03, k_{φ}=0.03, which are used in all the following simulations and the flight experiments. The initial states are p(0)=[0, 0.01, 0]^{T} and a(0)=[0, 0.01, 0]^{T}. The video showing the simulation results and the designed coaxial drone's real flight tests has been uploaded in the supplementary materials available online, due to space limitations.

### Mathematical Model Simulation in MATLAB

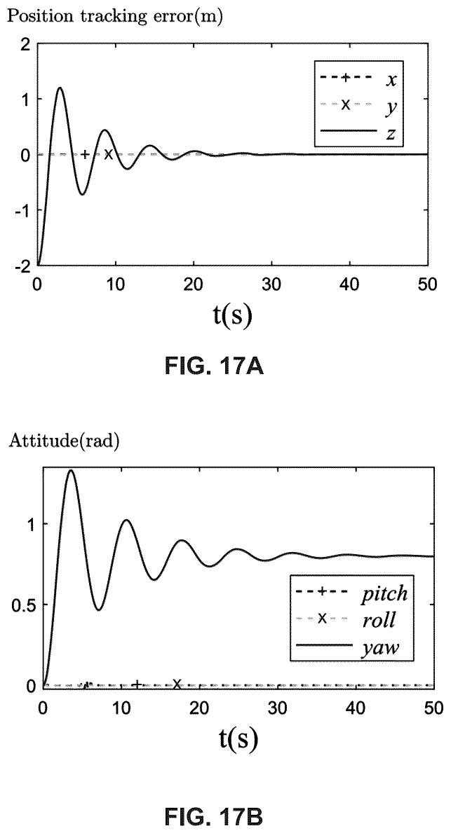

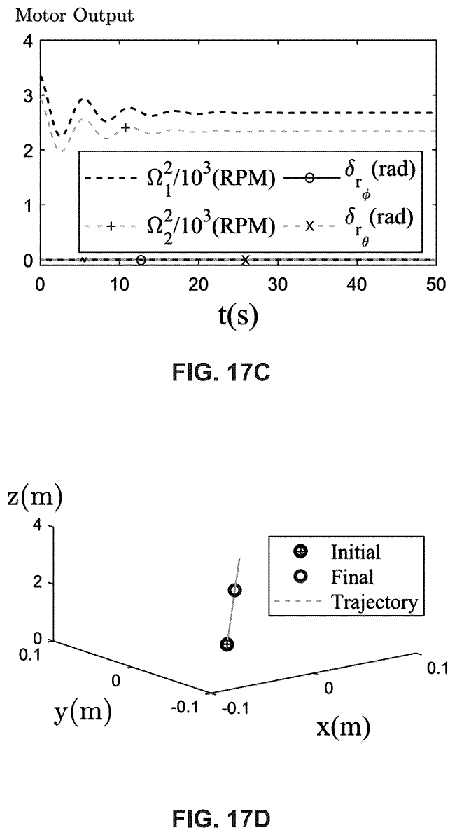

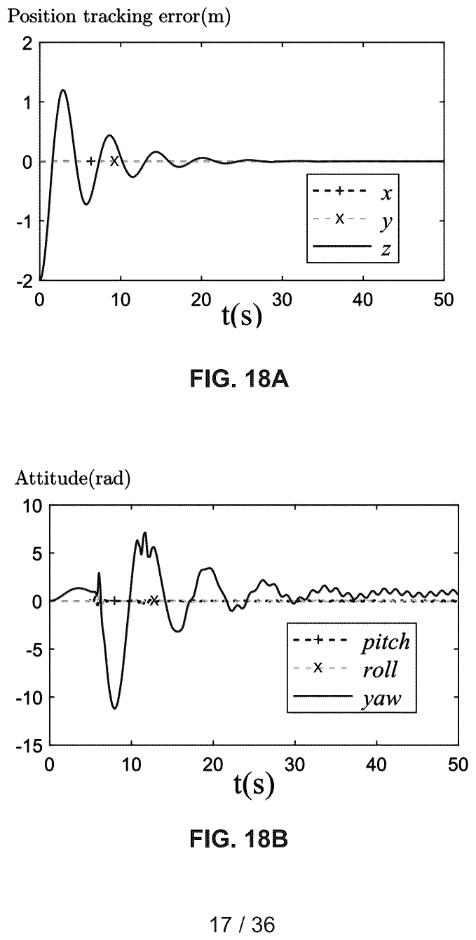

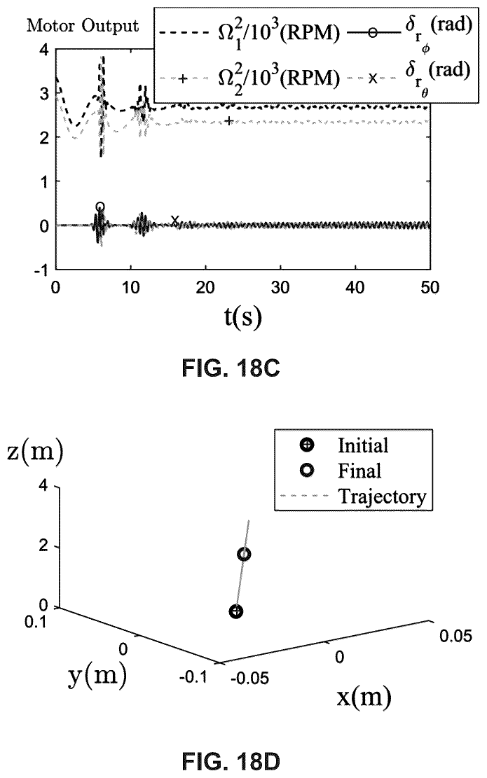

Simulation was conducted upon the established mathematical model (19). First, a hovering mission for the drone was considered by assigning the desired position as p^{d}[0, 0, 2]^{T} m and desired yaw angle as ψ^{d}=0.8 rad. Under the gain parameters kₚ=0.8, k_{d}=0.23 and the damping terms (35) and (36), the simulation results are shown in FIGS. 17A to 17D. From the position tracking error and the evolution of the drone's attitude, one can see that the desired position and desired yaw angle are achieved within about 25 s. The four motors' output shows that each propeller will produce about mg/2[N] thrust when the position of the drone reaches its destination. The trajectory of the drone is also shown in FIG. 17D. To show the effect of the proposed damping terms in (35) and (36), a mathematical model simulation was conducted for the hovering case with the same gain parameters but without the damping terms (35) and (36). According to the simulation results in FIGS. 18A to 18D, although the position tracking error, pitch angle and roll angle become smaller, the yaw angle is unstable, and the output of the servomotors is unstable. This validates that the proposed damping terms (35) and (36) are very important in the stabilization of the drone's attitude.

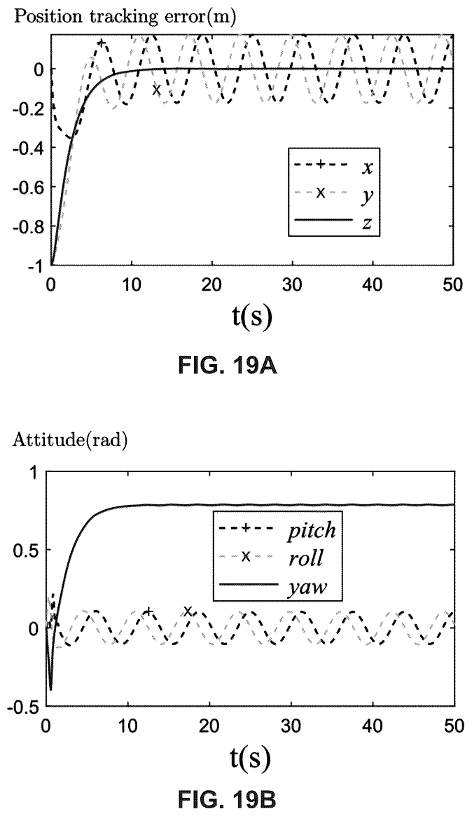

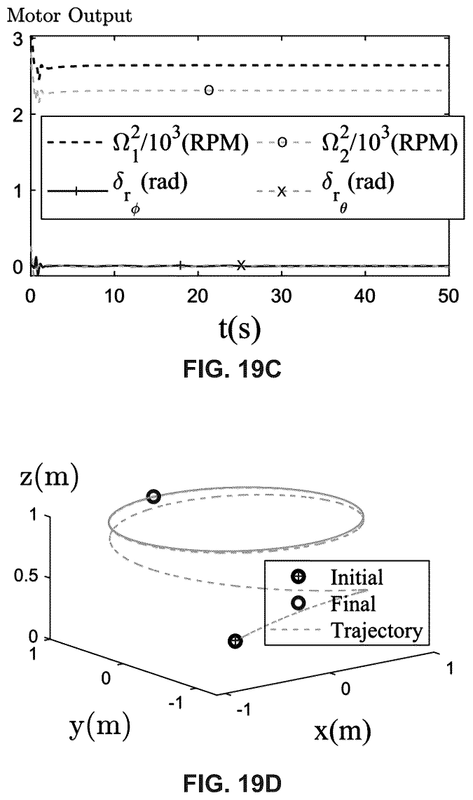

Thereafter, a maneuvering mission for the drone was considered by assigning the desired position as p^{d}(t)=[sin t, cos t, 1]^{T}m and desired yaw angle as ψ^{d}=0.8 rad. By using the gain values kₚ=0.8, k_{d}=2, the simulation results are shown in FIGS. 19A to 19D. For the maneuvering case, one can also see that the desired position and yaw angle are achieved within about 20 s, where small tracking errors exist in x and y directions. Note that when the drone achieves the maneuvering mission, the row and pitch angles change periodically, and the outputs of the two servomotors also change periodically. This is because the desired maneuvering trajectory changes periodically. FIG. 19D shows that the desired trajectory is achieved by the drone. This validates the effectiveness of the proposed control strategy for the coaxial drone in tracking a time-varying trajectory.

### Physical Model Simulation in Unreal Engine

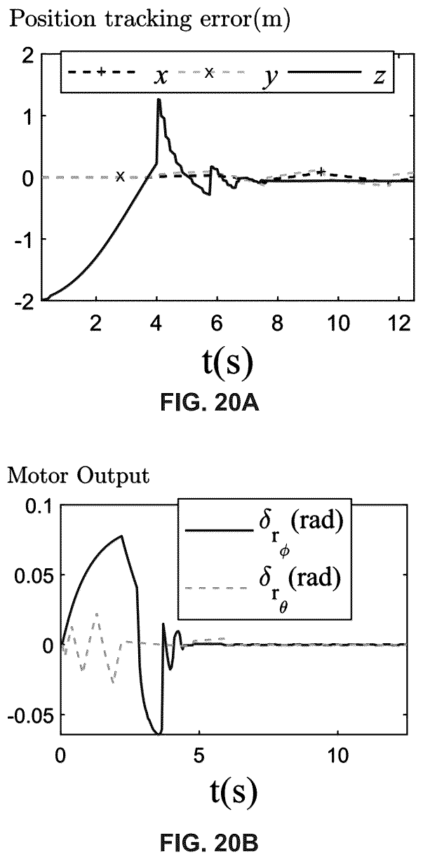

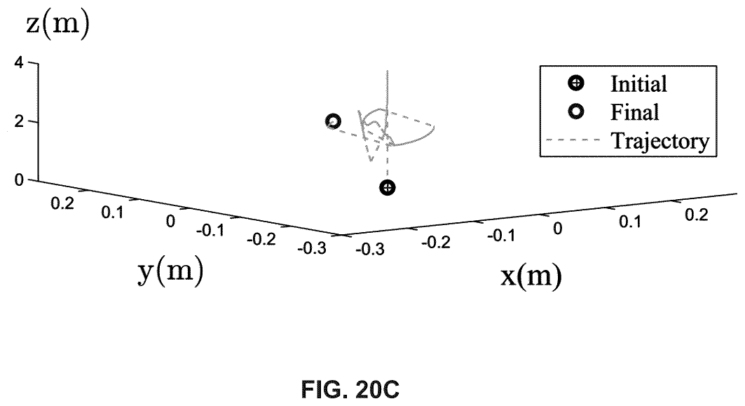

This simulation was conducted on the physical drone model established in Unreal Engine software, which is exported from Solidworks. Hovering and maneuvering tasks were both considered with the same desired trajectories. To compare with the mathematical simulation, the same PD gain values were used in this simulation. However, to eliminate constant convergence errors, PID was employed in this simulation, where the gain for the integral term is 0.98. The simulation results for the hovering case are provided in FIGS. 20A to 20C, where the output of servomotors, the evolution of the flight trajectory and position tracking error are similar between FIGS. 17A to 17D and 20A to 20C.

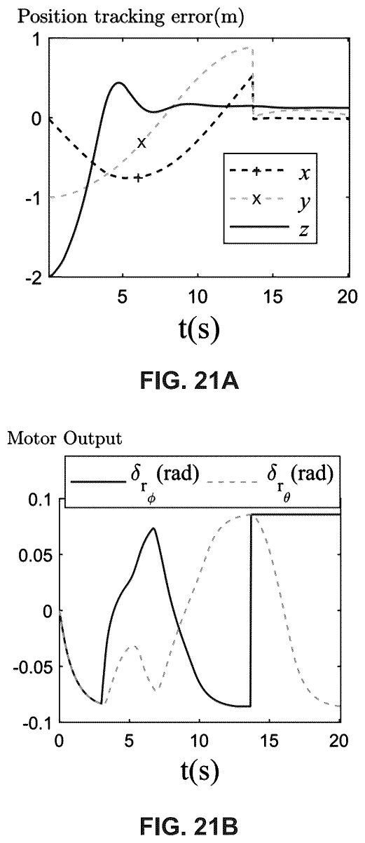

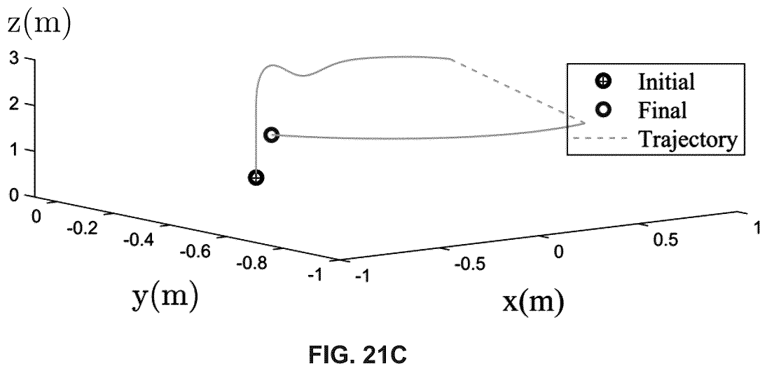

The simulation results for the maneuvering case are provided in FIGS. 21A to 21C. Compared to FIGS. 19A to 19D, the flight trajectory and the output of the servomotors are similar in FIGS. 21A to 21C. These simulation results validate that the established mathematical model of the drone is close to the physical model of the drone in the simulation environment, in which the difference is mainly caused by the modelling error.

### Real-Flight Experiments

In this section, four classes of experimental tests were conducted on the proposed physical coaxial drone to validate its design and the proposed control strategy. The first two classes of experiments aim to validate the design by testing the coaxial propellers' thrust efficiency and comparing the thrust produced by the coaxial drone and quadrotors. The latter two classes of experiments aim to validate the proposed control strategy by testing the effect of the designed damping terms and testing the hovering flight. Note that the values of thrust efficiency and lumped thrust and moment coefficients are obtained in later section, which are used in the aforementioned simulation examples. The gain values employed in the follow-up experiments are the same as those in the previous MATLAB simulation.

### System Framework and Components' Connection

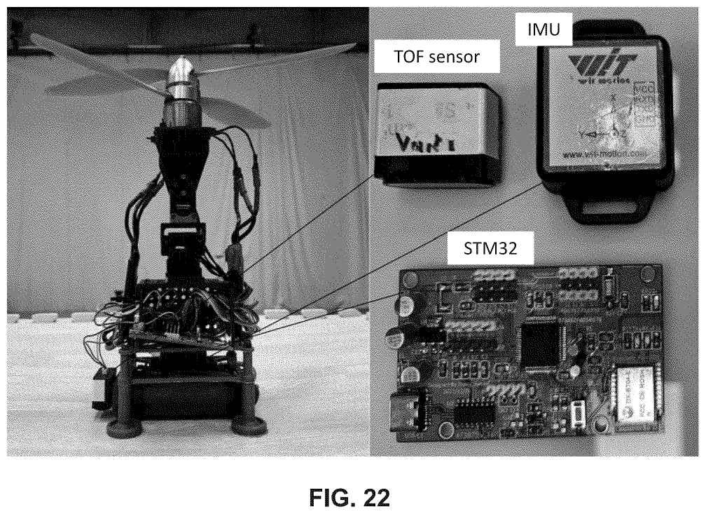

As shown in FIG. 22, the physical drone follows the configuration as introduced in earlier section, where four components are stacked in the fuselage, including battery, STM32 micro controller unit (MCU), IMU sensor, and time of flight (TOF) sensor (which can be used to measure the flight height during each updating interval).

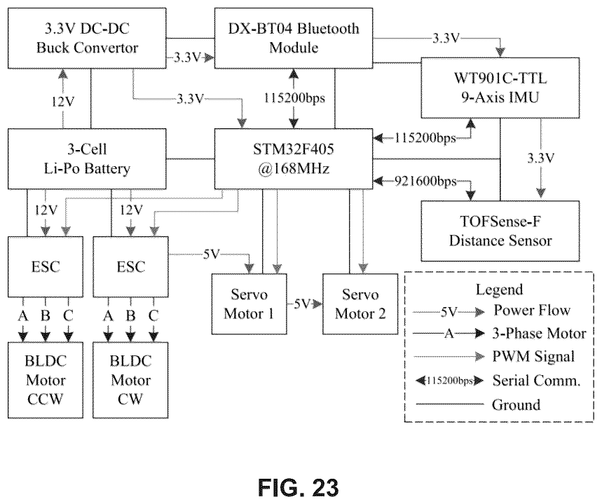

As shown in FIG. 23, the electronic components in the drone are organized in a manner to optimize overall flow of power and signals' connection. Specifically, the coaxial drone is powered by a 3S Li—Po battery, where voltage regulators are employed to obtain suitable operating voltages for other components. The flight controller is implemented upon the MCU STM32F405RGT6 at a core frequency of 168 MHz. The codes inside the MCU are developed and debugged on VSCODE and PlatformIO IDE with C++. The MCU communicates with the host computer through the DX-BT04 Bluetooth module at a baud rate of 115 200 bps via the channel USART1, where the transmitted data consists of control commands (such as takeoff and landing) and preset parameters. IMU data are transmitted by the channel USART2 under an interrupt mode at a baud rate of 115200 bps. TOF sensor data are transmitted by the channel USART3 under an interrupt mode at a baud rate of 921600 bps. The control algorithm proposed in this present application is executed under the timer interrupt with an updating frequency of 250 Hz. The magnitude of the four control outputs is represented by pulse width modulation (PWM) signals with a common frequency of 100 Hz, which are used to control the propellers and servomotors.

The MCU sets four interrupt priority levels, where the order is USART1, timer interrupt, USART3, and USART2. After the drone is powered on, it enters the initialization mode and waits for a JSON-formatted string input to adjust target height, PID parameters, damping ratio, servo sensitivity, and other parameters. After initialization is complete, the drone will fly autonomously according to the calculated control commands. During flight, the MCU will also upload the control commands, and the sensing data obtained from, e.g., IMU to the host computer via the Bluetooth at a frequency of 25 Hz.

### Experimental Tests on the Thrust Efficiency

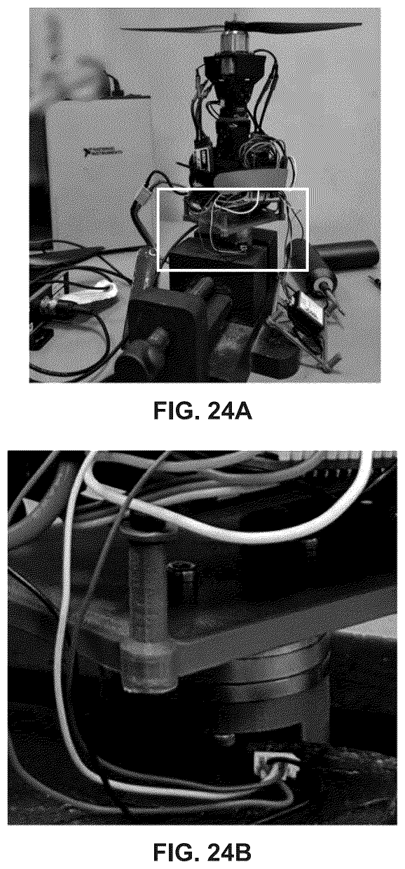

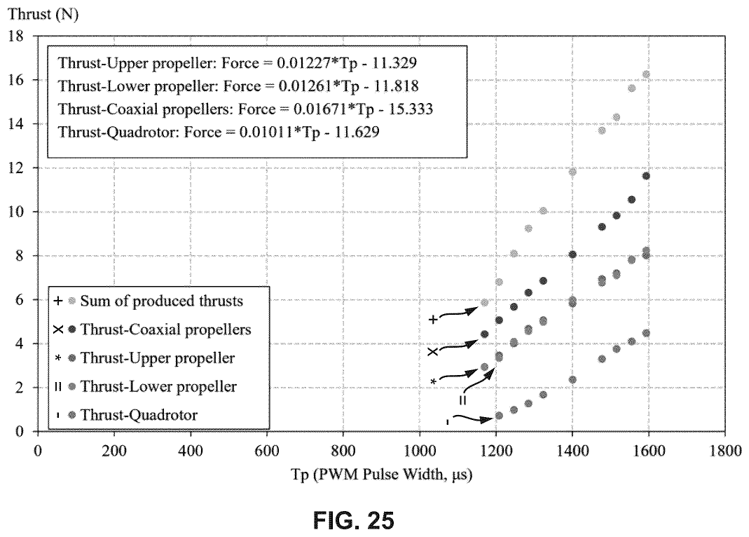

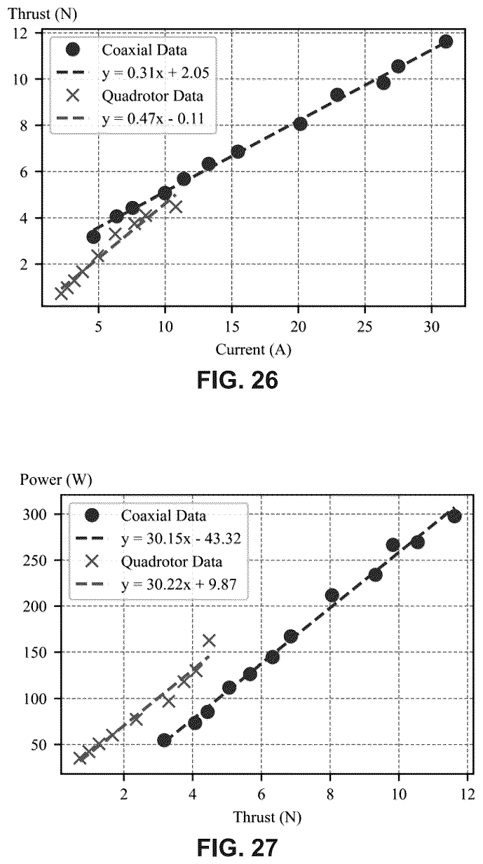

The coaxial drone's thrust efficiency plays an important role in later sections for which experiments were designed to test the respective values. The testing platform is shown in FIG. 24A. A high-precision sensor, ATI DAQ Net F/T4, was used to measure the force and torque produced by the drone. The upper side of the sensor is rigidly attached to the bottom of the drone, and the bottom side of the sensor is fixed by a ground station, as shown in FIG. 24B. Using the software from the company ATI, the force and torque applied to the drone, which is produced by the rotation of the propellers, may be read. FIG. 25 shows the testing data and the fitting relation from the PWM signal (produced from electronic speed controller, ESC) to the produced thrust. The existence of energy loss is clearly shown in FIG. 25 since the sum of the individual propeller's produced thrust is higher than the thrust produced by the coaxial propellers. Using these testing data, the energy loss coefficients of the thrust is approximated as

$$σ \approx \frac{0.0167}{0.0122 + 0.0126} \approx 67.3 \% ,$$

in which ESC's PWM value was used to replace the propellers' rotating speed in this calculation since the propellers' rotating speed is unavailable and the rotation of the propellers are controlled by the ESC. To further show the thrust efficiency, the testing results on the drone's produced current, thrust, and power are available in FIGS. 26 and 27. The current and power are measured by a specialized instrument MDA 8000HD Motor Drive Analyzers.

### Thrust Comparison Between the Coaxial Drone and a Quadrotor

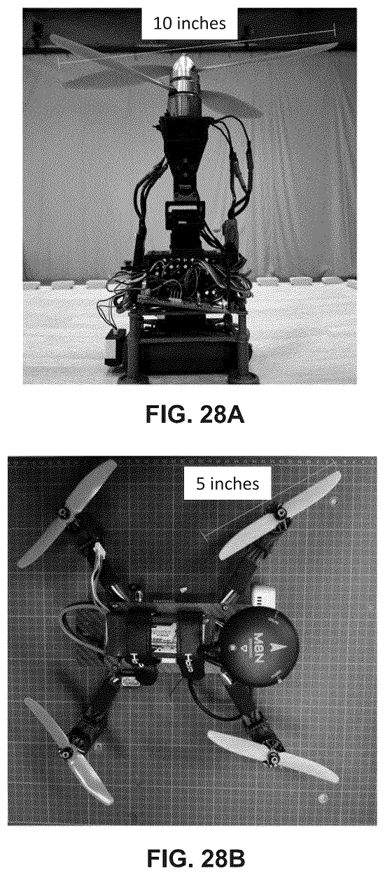

Actual experiments on the coaxial drone and a quadrotor were conducted with the quadrotor's propeller size half of that of the coaxial drone, as shown in FIGS. 28A and 28B. The experiments are also conducted on the testing platform introduced in FIG. 24A. To have a fair comparison, the other testing conditions, parameters and devices are kept the same as much as possible, such as the ESC. The testing results are shown in FIG. 25, which indicates that the coaxial drone's produced thrust is always larger than that of the quadrotor. Using these data given in FIG. 25, the range of

$$\frac{Thrust - Coaxial propellers}{Thrust - Quadrotor}$$

can be calculated, which is (2.75, 9.38). Indeed, the corresponding theoretical radio

$$\frac{1.3}{1 / 4} = 5.2$$

as given in later section is in this experimental range. Furthermore, the comparison of current and power for the coaxial drone and quadrotor is provided in FIGS. 26 and 27, from which one has that with the same produced thrust, the quadrotor needs higher current and power than that of the coaxial drone.

### Experimental Tests on the Damping Gains and Motors' Updating Frequency

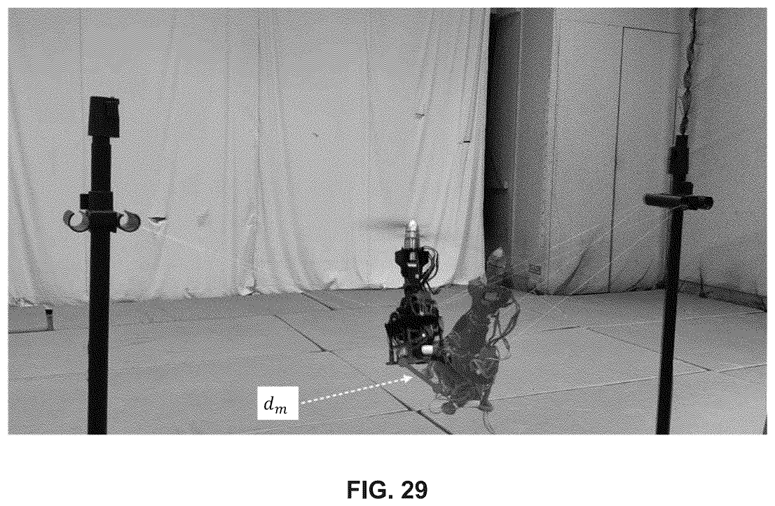

The four control gains and motors' updating frequency determine the coaxial drone's system performance. Thus, the intention of this section is to obtain the best control gains and updating frequency for flights by testing the system response under different parameters. As shown in FIG. 29, when the drone's initial height is exactly or very close to the desired height (realized by suspending the drone with two lines connected with two ground poles), the drone's motion along yaw axis is minor. Then, the oscillation of the drone along the roll axis describes the system performance of the drone's dynamics along the roll axis (the motion along the pitch axis is restricted by the lines). Therefore, as shown in FIG. 29, the maximum distance dₘ of the drone's motion in the horizontal plane was used to approximately characterize the system performance of the drone's roll dynamics. Then, one has dₘ≈|max x[k̅]−min x[k], ∀k̅, k=1, 2, . . . , which can be obtained from on-board sensor measurements, specifically the motion distance and the drone's attitude. The testing results are summarized in Table II. From the table, the best parameters are k_{θ}=0.03, k_{φ}=0.03, fₛₑᵣᵥₒ=250 Hz since the oscillation is minimum among these cases.

TABLE II
Effect of Damping Gains and Updating Frequency

Properties

| Parameters | Tested values | Response dₘ |
|---|---|---|
| Damping gains k_{θ} = k_{φ} | 0 | 10 cm |
| | 0.3 | 5 cm |
| | 0.15 | Unstable |
| Motors' updating frequency | 25 Hz | 30 cm |
| | 50 Hz | 20 cm |
| | 250 Hz | 5 cm |

### Experimental Tests on Vertical Ascending Flight

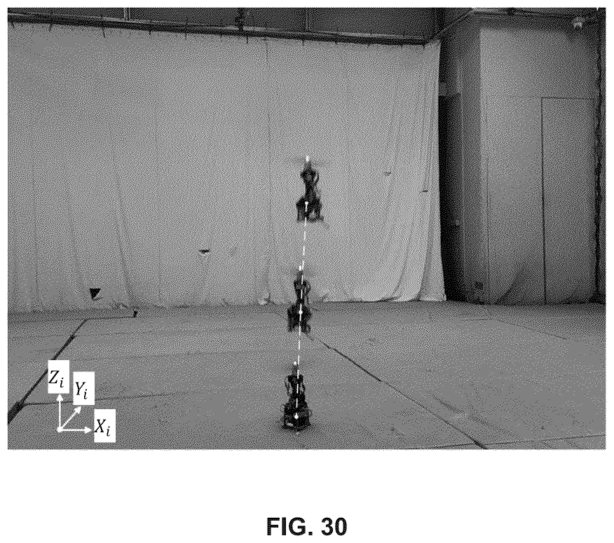

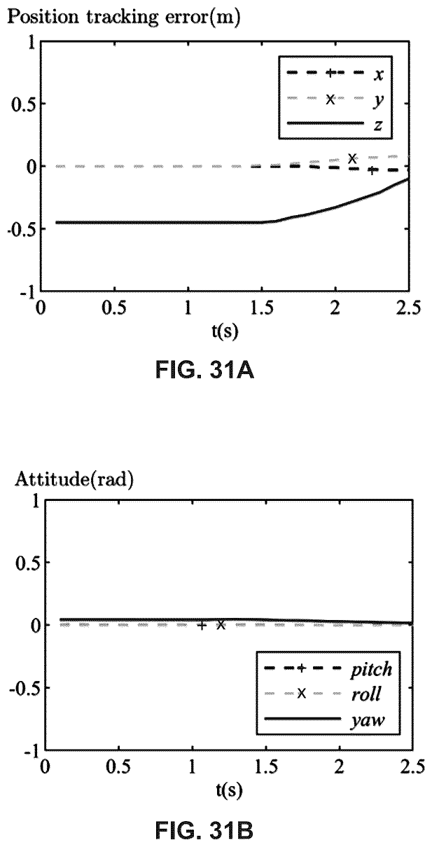

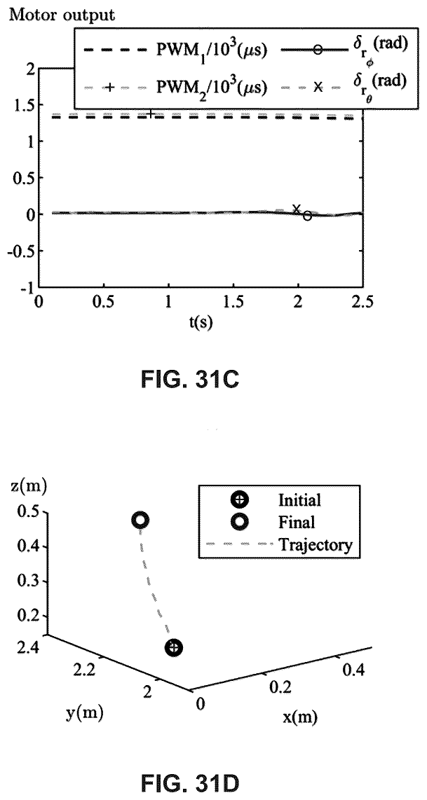

In the experimental tests, vertical ascending flight where the drone is commanded to reach a target height was conducted. Indeed, to achieve such mission, accurate height measurements are needed, which is based on the fusion of the TOF and IMU measurements since TOF sensor measures motion distance and IMU measures the drone's attitude. The drone's flight results are shown in FIGS. 30, 31A to 31D. To validate the proposed control strategy, a flight control platform for the coaxial drone was developed. Due to the absence of a global positioning system, the maneuvering flight task is challenging, for which the maneuvering flight under a manual control mode was tested.

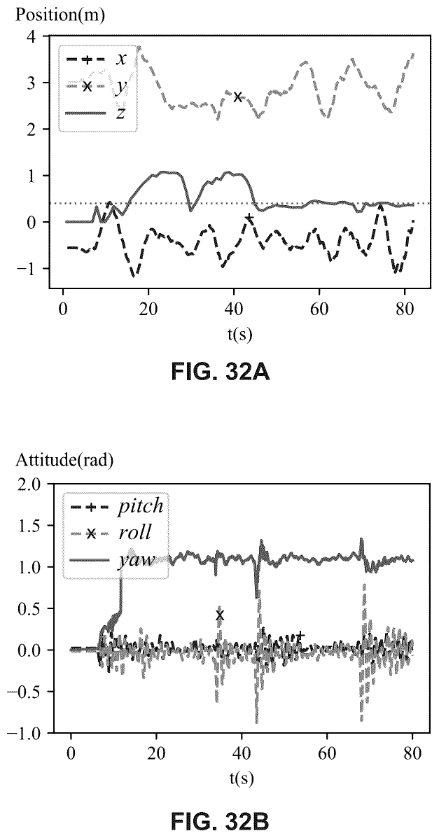

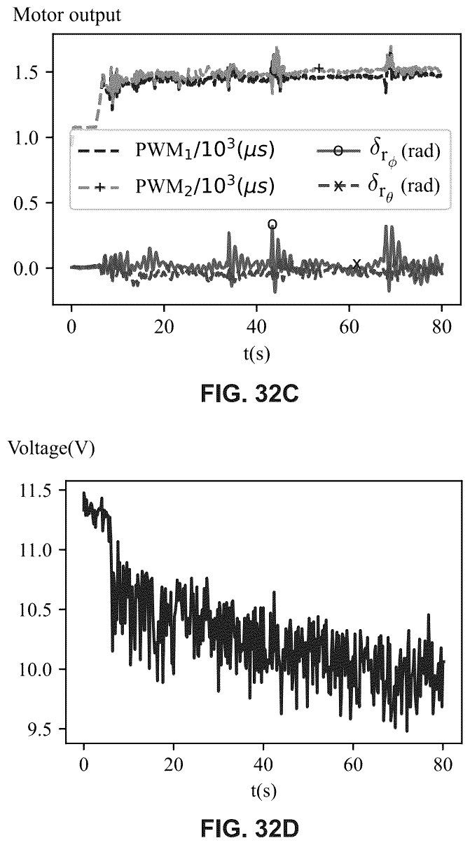

Meanwhile, based on the analysis of the experimental data in the above-mentioned ascending flight, it is observed that the drone became less stable when it operated in the air for a longer time. Specifically, after the drone reaches the desired position, it gradually becomes less stable. This is mainly caused by the measurement inaccuracy (or error accumulation) of the drone's state from IMU, which is directly included in the drone's control algorithm. Therefore, to avoid this issue, the platform is also tested based on the advanced sensor fusion and filtering techniques embedded in Pixhawk 4 mini, in which the existing control allocation framework is employed. The flight results are shown in FIGS. 32A to 32D. According to FIGS. 32A and 32D, the attitude and position of the drone are almost maintained, and the motors' output is relatively stable during the hover. This further demonstrates the effective design of the drone and highlights the contributions of the experiments.

Comparing the experimental data with the simulation data, one has that there exist common aspects and differences. The common aspects include the effect of the damping components and the trend of the control outputs, while the differences include the employed gain values and the system evolution. The reason for the difference may be due to modelling inaccuracy, for which the best gain for the simulation example might not be the best for the experiment. Although there exist differences, the established mathematical model helps us understand the drone and propose a controller, and the simulations help us verify them rapidly.

As disclosed in the present application, an innovative coaxial drone was proposed such that the advantages of maximum thrust per platform area and flight maneuverability can be simultaneously actualized using thrust-vectoring coaxial propellers. The contra-rotating coaxial propellers can be actuated using a left-right tilt servomotor and a back-forward tilt servomotor connected vertically in series. The drone's position and attitude dynamics with six DoF have been modelled, which is underactuated since the number of the control inputs is only four. An efficient controller with a nonlinear control allocation has been proposed. For the uncontrolled roll and pitch dynamics, a damping part has been delicately added such that the roll and pitch angular velocities can also be stabilized. Both numerical simulations and real experiments have been conducted, which have validated the effectiveness of the drone design, the established model and the proposed control strategy.

All examples described herein, whether of methods, materials, or products, are presented for the purpose of illustration and to aid understanding and are not intended to be limiting or exhaustive. Modifications may be made by one of ordinary skill in the art without departing from the scope of the invention as claimed.

1. An aerial vehicle, comprising:
a housing defining a housing axis, the housing axis passing through a centre of mass of the housing;
a first motor coupled to the housing, the first motor including a first output shaft defining a first output axis;
a first mount coupled the first output shaft, the first mount angularly displaceable about the first output axis by the first output shaft;
a second motor coupled to the first mount, the second motor including a second output shaft defining a second output axis;
a second mount coupled to the second output shaft, the second mount angularly displaceable about the second output axis by the second output shaft;
a pair of propellers coupled to the second mount, the pair of propellers rotatable about a common propeller axis, wherein the pair of propellers define a volumetric thrust stream along the common propeller axis, wherein the centre of mass of the housing is disposed interior of the volumetric thrust stream.

2. The aerial vehicle as recited in claim 1, wherein each of the first output axis and the second output axis is orthogonal to the housing axis.

3. The aerial vehicle as recited in claim 1, wherein the first output axis and the second output axis are orthogonal to one another.

4. The aerial vehicle as recited in claim 1, wherein the pair of propellers are spaced apart from each other along the common propeller axis, wherein the pair of propellers are counter-rotating propellers.

5. The aerial vehicle as recited in claim 1, wherein the pair of propellers define a common propeller diameter.

6. The aerial vehicle as recited in claim 1, wherein in a neutral state, the common propeller axis is substantially coaxially aligned with the housing axis.

7. The aerial vehicle as recited in claim 6, wherein the pair of propellers are spaced apart from the housing along the housing axis, such that a counter moment acts on the aerial vehicle responsive to a disturbance on the aerial vehicle.

8. The aerial vehicle as recited in claim 6, wherein in the neutral state, the volumetric thrust stream is substantially parallel to the housing axis.

9. The aerial vehicle as recited in claim 1, further comprising a holder coupled to the housing, the holder being configured to detachably couple to a load.

10. The aerial vehicle as recited in claim 9, wherein the holder extends exterior of the volumetric thrust stream.

11. The aerial vehicle as recited in claim 1, wherein a first orientation of the first mount relative to the housing is controllable by the first output shaft solely.

12. The aerial vehicle as recited in claim 11, wherein a second orientation of the second mount relative to the housing is controllable by the first output shaft and the second output shaft collectively.

13. An aerial vehicle system for moving a load, comprising:
multiple ones of the aerial vehicle as recited in claim 1; and
a control station, the control station being configured to independently wirelessly control each of the multiple ones of the aerial vehicle.

14. The aerial vehicle system as recited in claim 13, wherein the control station is configured to independently control each of the multiple ones of the aerial vehicle to:
detachably couple with a respective coupling point of the load, the load comprising multiple coupling points; and
move to a respective target position to vary a position of the load, wherein each of the respective target position is distinct from one another.

15. The aerial vehicle system as recited in claim 14, wherein the control station is further configured to independently control each of the multiple ones of the aerial vehicle to: move to a respective target position to vary an orientation of the load.

16. The aerial vehicle system as recited in claim 14, wherein the control station is further configured to: determine each of the respective target position based on at least one geometrical dimension of the load.

17. The aerial vehicle system as recited in claim 14, wherein the multiple coupling points are non-symmetrically and non-uniformly distributed on the load.

18. The aerial vehicle system as recited in claim 14, wherein the multiple ones of the aerial vehicle define a lifting space, wherein the load is disposed at least partially in the lifting space.

19. A method of aerial lifting, the method comprising:
detachably coupling a plurality of the aerial vehicles as recited in claim 1 to a plurality of coupling points of a load; and
independently controlling each of the aerial vehicle to a respective target position to vary a position of the load, wherein each of the respective target position is distinct from one another.

20. The method as recited in claim 19, further comprising independently controlling each of the aerial vehicle to a respective target position to vary an orientation of the load.
